(19) United States
(12) Patent Application Publication
(10) Pub. No.: US 2025/0230565 A1
(43) Pub. Date: Jul. 17, 2025

(54) POLYMERIC TEMPLATES FOR MICROSTRUCTURES AND METHODS OF USE THEREOF

(71) Applicant: Temple University-Of The Commonwealth System of Higher Education, Philadelphia, PA (US)

(72) Inventors: Long Zhu, Philadelphia, PA (US); Fei Ren, Chadds Ford, PA (US); Weixiao Gao, Marlton, NJ (US)

(21) Appl. No.: 19/024,851

(22) Filed: Jan. 16, 2025

Related U.S. Application Data
(60) Provisional application No. 63/621,795, filed on Jan. 17, 2024.

(51) Int. Cl. C25D 1/04; C08G 77/04

(52) U.S. Cl. CPC C25D 1/04; C08G 77/04

(57) ABSTRACT

The present invention provides a method of fabricating a template for the synthesis of at least one microstructure having a controlled geometry, wherein the method comprises the steps of: providing a Si substrate; depositing a layer of an oxide onto at least a portion of the surface of the Si substrate to provide a wafer; etching the wafer to provide a master mold comprising at least one pillar; coating the at least one pillar and at least a portion of the surface of the master mold with a polymeric material to generate the template; and releasing the template from the master mold; wherein the height of the at least one pillar is 100 μm to 1000 μm, and templates and synthesized microstructures thereof.

### CROSS-REFERENCE TO RELATED APPLICATIONS

This application claims priority to U.S. Provisional Patent Application Ser. No. 63/621,795, filed Jan. 17, 2024, the entire contents of which are incorporated herein by reference.

### BACKGROUND OF THE INVENTION

As a result of their structural anisotropy, vertically aligned one-dimensional (1D) structure arrays, such as nanowires (NWs), nanorods, nanoneedles, nanotubes, nanoribbons, and microwires (MWs) arrays, exhibit unique properties compared to their bulk counterparts. These properties include structural flexibility, mechanical compliance due to high aspect ratio, large specific surface area due to the size effect, and high surface-to-volume ratio (Kuchibhatla et al., 2007, Progress in Materials Science, 52, 699). Consequently, they serve as key building blocks for devices used in sensors, drug delivery, catalysis, photodetectors, energy storage and conversion, medical imaging, diagnosis and detection, molecular computing, and information storage (Tiano et al., 2010, Chemical Communications, 46, 8093; Barth et al., 2010, Science, 55, 563; Xia et al., 2003, Advanced Materials, 15, 353).

There is presently no technique in the open literature that describes the preparation of templates for growth/synthesis of microstructures with lengths in the range of hundreds of micrometers. Commercial technologies can only yield templates in the range of tens of micrometers or shorter.

Thus, there is a need for novel methods to fabricate polymer templates which can be used to synthesize microstructures with controlled geometries. The present invention satisfies this need.

### SUMMARY OF THE INVENTION

The present invention relates to a method of fabricating a template for the synthesis of at least one microstructure having a controlled geometry, wherein the method comprises the steps of: providing a Si substrate; depositing a layer of an oxide onto at least a portion of the surface of the Si substrate to provide a wafer; etching the wafer to provide a master mold comprising at least one pillar; coating the at least one pillar and at least a portion of the surface of the master mold with a polymeric material to generate the template; and releasing the template from the master mold; wherein the height of the at least one pillar is 100 μm to 1000 μm.

In some embodiments, the oxide is silicon oxide. In some embodiments, the step of etching the wafer is performed using reactive-ion etching. In some embodiments, the polymeric material is an elastomer. In some embodiments, the polymeric material comprises polydimethylsiloxane. In some embodiments, the step of coating the at least one pillar and at least a portion of the surface of the master mold with a polymeric material comprises spin coating of the polymeric material onto the master mold. In some embodiments, the present invention provides a template synthesized using the method described herein.

The present invention further relates to a method of fabricating a template for the synthesis of at least one microwire having a controlled geometry, comprising the steps of: providing a polymeric material; and drilling a plurality of holes into the polymeric material; wherein the plurality of holes have an average width between 5 μm and 50 μm and an average spacing between 5 μm and 50 μm.

In some embodiments, the polymeric material is an elastomer. In some embodiments, the step of drilling is performed using a laser. In some embodiments, the plurality of holes are cylindrical. In some embodiments, the present invention provides a template synthesized using the method described herein.

The present invention further relates to a method of making a microstructure comprising the steps of: providing a template comprising a plurality of pores having an average depth of 100 μm to 1000 μm; attaching the template to a substrate; exposing the template to a solution comprising a metal precursor; and reducing the metal precursor, thereby growing the microstructure on the template.

In some embodiments, the template is flexible. In some embodiments, the plurality of pores is cylindrical. In some embodiments, the solution comprising a metal precursor comprises the metal precursor in a concentration of 0.01 M to 5.0 M. In some embodiments, the metal precursor comprises copper. In some embodiments, the step of reducing the metal precursor is performed by supplying the solution with a constant voltage having a magnitude of 0.1 V to 1.0 V. In some embodiments, the microstructure is selected from the group consisting of a wire, a microwire, a nanowire, and a filament. In some embodiments, the present invention provides a microwire synthesized using the method described herein.

### BRIEF DESCRIPTION OF THE DRAWINGS

The following detailed description of various embodiments of the invention will be better understood when read in conjunction with the appended drawings. For the purpose of illustrating the invention, these are shown in the drawings illustrative embodiments. It should be understood, however, that the invention is not limited to the precise arrangements and instrumentalities of the embodiments shown in the drawings.

FIG. 1, comprising FIG. 1A and FIG. 1B, depicts schematic representations of the preparation of the silicon (Si) micropillar master and a representative scanning electron microscopy (SEM) image of the obtained Si micropillar master. FIG. 1A depicts a schematic representation showing the preparation of the Si micropillar master. FIG. 1B depicts a representative SEM image of the obtained Si micropillar master.

FIG. 2 depicts a schematic illustration of the substeps involved in the preparation of the polydimethylsiloxane (PDMS) template membrane with through holes using the Si master.

FIG. 3, comprising FIG. 3A through FIG. 3D, depicts representative images of steps in the copper microwire synthesis. FIG. 3A depicts a representative SEM image showing a polydimethylsiloxane (PDMS) template that is about to be released from a Si micropillar master.

FIG. 3B depicts a representative SEM image of the top surface of the free standing PDMS membrane. FIG. 3C depicts a representative SEM image of the Si micropillar master after PDMS was released. FIG. 3D depicts a representative SEM image of copper microwires.

FIG. 4 depicts a schematic illustration of the setup for the electrodeposition of copper microwires (Cu MWs).

FIG. 5, comprising FIG. 5A and FIG. 5B, depicts a representative load scratch test. FIG. 5A depicts a schematic illustration of the scratch on Cu MWs. FIG. 5B depicts an example of the load function used for the scratch test. The normal load is 3 N, and the scratch length is 1.5 mm.

FIG. 6, comprising FIG. 6A through FIG. 6C, depicts additional SEM images. FIG. 6A depicts a representative SEM image of the bare Si master. FIG. 6B depicts a representative SEM image of the Parylene-C coated Si master. FIG. 6C depicts a representative SEM image of the S1805 coated Si master.

FIG. 7, comprising FIG. 7A through FIG. 7C, depicts additional SEM images. FIG. 7A depicts an SEM image of a piece of PDMS template about to be released from the Si micropillar master mold. FIG. 7B depicts an SEM image of the top surface of a free-standing PDMS template membrane. FIG. 7C depicts an SEM image of the bottom surface of a free-standing PDMS template membrane. Scale bar: 200 μm.

FIG. 8 depicts SEM images of the Cu MWs prepared using the PDMS template, scale bar: 100 μm.

FIG. 9 depicts an example of the curves of lateral force and normal displacement vs. time recorded during the scratch test.

FIG. 10 depicts SEM images of the Cu MWs after the scratch test at low (a) and high (b) magnifications.

FIG. 11 depicts representative images of PDMS films with microholes using the laser micromachining technique.

### DETAILED DESCRIPTION

The present invention is based, in part, on the unexpected results that using polydimethylsiloxane (PDMS) templates produced one-dimensional metal or alloy structures with controlled geometry and with lengths in the range of hundreds of micrometers. Thus, in one aspect, the present invention provides a one polymeric material having a controlled geometry. In another aspect, the present invention provides a method of fabricating a polymeric material having a controlled geometry. In one aspect, the present invention provides a method of fabricating a template for synthesis of a polymeric material having a controlled geometry. In one aspect, the present invention provides a template comprising a polymeric material having a controlled geometry.

### Definitions

It is to be understood that the Figures and descriptions of the present invention have been simplified to illustrate elements that are relevant for a clear understanding of the present invention, while eliminating, for the purpose of clarity, many other elements found in polymer composites and methods of making. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e., to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of ±20% or ±10%, including, for example, ±5%, ±1%, and/or ±0.1% from the specified value, as such variations are appropriate to perform the disclosed methods.

As used herein the term “nanostructure” refers to a structure on the sub-micrometer scale which includes one or more particles, each being on the nanometer or sub-nanometer scale and commonly abbreviated “nanoparticle”. The distance between different elements (e.g., nanoparticles, molecules) of the structure can be of order of several tens of picometers or less, in which case the nanostructure is referred to as a “continuous nanostructure”, or between several hundreds of picometers to several hundreds of nanometers, in which the nanostructure is referred to as a “discontinuous nanostructure”. Thus, the nanostructure of the present embodiments can comprise a nanoparticle, an arrangement of nanoparticles, or any arrangement of one or more nanoparticles and one or more molecules.

As used herein, the term “nanowire” generally refers to any elongated conductive or semiconductive material (or other material described herein) that includes at least one cross sectional dimension that is less than 500 nm, including, for example, less than 100 nm, and has an aspect ratio (length:width) of greater than 10, including, for example, greater than 50, greater than 100, and/or greater than 1000.

The nanowires of this invention can be substantially homogeneous in material properties, or in certain embodiments can be heterogeneous (e.g., nanowire heterostructures). The nanowires can be fabricated from essentially any convenient material or materials, and can be, e.g., substantially crystalline, substantially monocrystalline, polycrystalline, or amorphous. Nanowires can have a variable diameter or can have a substantially uniform diameter, that is, a diameter that shows a variance less than about 20% (e.g., less than about 10%, less than about 5%, or less than about 1%) over the region of greatest variability and over a linear dimension of at least 5 nm (e.g., at least 10 nm, at least 20 nm, or at least 50 nm). Typically the diameter is evaluated away from the ends of the nanowire (e.g. over the central 20%, 40%, 50%, or 80% of the nanowire). A nanowire can be straight or can be e.g. curved or bent, over the entire length of its long axis or a portion thereof. In certain embodiments, a nanowire or a portion thereof can exhibit two- or three-dimensional quantum confinement. Nanowires according to this invention can expressly exclude carbon nanotubes, and, in certain embodiments, exclude “whiskers” or “nanowhiskers”, particularly whiskers having a diameter greater than 100 nm, or greater than about 200 nm. Examples of such nanowires include semiconductor nanowires as described in Published International Patent Application Nos. WO 02/17362, WO 02/48701, and WO 01/03208, carbon nanotubes, and other elongated conductive or semiconductive structures of like dimensions, which are incorporated herein by reference.

As used herein, the terms “microstructure” or “microstructures” refer to structures that range from about 0.1 microns to about 1000 microns in their longest dimension.

As used herein the term “microwire” refers to a structure on the micrometer scale which includes one or more particles, each being on the micrometer or sub-micrometer scale and commonly abbreviated “microparticle”. The distance between different elements (e.g., microparticles, molecules) of the structure can be of order of several tens of picometers or less, in which case the microstructure is referred to as a “continuous microstructure”, or between several hundreds of picometers to several hundreds of micrometers, in which the microstructure is referred to as a “discontinuous microstructure”. Thus, the microstructure of the present embodiments can comprise a microparticle, an arrangement of microparticles, or any arrangement of one or more microparticles and one or more molecules.

As used herein, the term “microwire” generally refers to any elongated conductive or semiconductive material (or other material described herein) that includes at least one cross sectional dimension that is less than 500 μm, including, for example, less than 100 μm, and has an aspect ratio (length:width) of greater than 10, including, for example, greater than 50, greater than 100, and/or greater than 1000.

The microwires of this invention can be substantially homogeneous in material properties, or in certain embodiments can be heterogeneous (e.g., microwire heterostructures). The microwires can be fabricated from essentially any convenient material or materials, and can be, e.g., substantially crystalline, substantially monocrystalline, polycrystalline, or amorphous. Microwires can have a variable diameter or can have a substantially uniform diameter, that is, a diameter that shows a variance less than about 20% (e.g., less than about 10%, less than about 5%, or less than about 1%) over the region of greatest variability and over a linear dimension of at least 5 nm (e.g., at least 10 nm, at least 20 nm, or at least 50 nm). Typically the diameter is evaluated away from the ends of the microwire (e.g. over the central 20%, 40%, 50%, or 80% of the microwire). A microwire can be straight or can be e.g. curved or bent, over the entire length of its long axis or a portion thereof. In certain embodiments, a microwire or a portion thereof can exhibit two- or three-dimensional quantum confinement. Microwires according to this invention can expressly exclude carbon microtubes, and, in certain embodiments, exclude “whiskers” or “microwhiskers”, particularly whiskers having a diameter greater than 100 nm, or greater than about 200 nm.

Any embodiment involving a nanostructure or nanowire disclosed herein is applicable to any embodiment involving a microstructure or microwire, and vice-versa.

As used herein, the term “micropillar” is intended to refer to any microstructure comprising a cylindrical shape.

As used herein “polymer” refers to homopolymers (formed by polymerization of a single monomer species) and co-polymers (formed by polymerization of a plurality of different monomer species), including linear polymers and cross-linked polymers. In some embodiments, the polymer or copolymer can be a non-crosslinked or sparsely cross-linked polymer or copolymer. In some embodiments, the polymer or copolymer can be crosslinked. In some embodiments, the polymer or copolymer can be a linear polymer or copolymer. Any polymer exhibiting functional stability can be used in the compositions and methods described herein. In some embodiments, the polymer or copolymer can be an uncharged water-soluble silica-adsorbing polymer or copolymer, a non-crosslinked acrylamide polymer or copolymer, a cellulose polymer or copolymer, a poly(alkylene oxide) polymer or copolymer, a polysaccharide, or a triblock copolymer.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Methods of Fabricating Templates

In one aspect, the present invention relates to a method of fabricating a template for the synthesis of at least one microstructure having a controlled geometry. In one aspect, the present invention relates to a method of fabricating a template for the synthesis of at least one microstructure of the present invention. In one aspect, the present invention relates to a method of fabricating at least one template of the present invention.

In some embodiments, the method comprises the steps of: providing a Si substrate, depositing a layer of an oxide onto at least a portion of the surface of the Si substrate to provide a wafer, etching the wafer to provide a master mold comprising at least one pillar, coating the at least one pillar and at least a portion of the surface of the master mold with a polymeric material to generate the template; and releasing the template from the master mold.

In some embodiments, the method comprises the steps of providing a Si substrate, depositing a layer of an oxide onto the Si substrate to provide a wafer, etching the wafer to provide a master template, putting a polymeric material onto the master template, and releasing the polymeric material from the master template.

In some embodiments, the Si substrate is a Si wafer. In some embodiments, the Si substrate is crystalline. In some embodiments, the Si substrate comprises at least one defect. In some embodiments, the Si substrate is a defect-free Si substrate.

In some embodiments, the Si substrate is a Si wafer. In some embodiments, the Si substrate is crystalline. In some embodiments, the Si substrate contains defects. In some embodiments, the thickness of the Si substrate is about 1 inch to about 10 inches. In some embodiments, the thickness of the Si substrate is about 1 inch to about 9 inches. In some embodiments, the thickness of the Si substrate is about 1 inch to about 8 inches. In some embodiments, the thickness of the Si substrate is about 1 inch to about 7 inches. In some embodiments, the thickness of the Si substrate is about 1 inch to about 6 inches. In some embodiments, the thickness of the Si substrate is about 1 inch to about 5 inches. In some embodiments, the thickness of the Si substrate is about 1 inch to about 4 inches. In some embodiments, the thickness of the Si substrate is about 1 inch to about 3 inches. In some embodiments, the thickness of the Si substrate is about 1 inch to about 2 inches. In some embodiments, the thickness of the Si substrate is about 1 inch to about 1.5 inches. In some embodiments, the thickness of the Si substrate is about 2 inches to about 10 inches. In some embodiments, the thickness of the Si substrate is about 2 inches to about 9 inches. In some embodiments, the thickness of the Si substrate is about 2 inches to about 8 inches. In some embodiments, the thickness of the Si substrate is about 2 inches to about 7 inches. In some embodiments, the thickness of the Si substrate is about 2 inches to about 6 inches. In some embodiments, the thickness of the Si substrate is about 2 inches to about 5 inches. In some embodiments, the thickness of the Si substrate is about 2 inches to about 4 inches. In some embodiments, the thickness of the Si substrate is about 2 inches to about 3 inches. In some embodiments, the thickness of the Si substrate is about 3 inches to about 9 inches. In some embodiments, the thickness of the Si substrate is about 3 inches to about 8 inches. In some embodiments, the thickness of the Si substrate is about 3 inches to about 7 inches. In some embodiments, the thickness of the Si substrate is about 3 inches to about 6 inches. In some embodiments, the thickness of the Si substrate is about 3 inches to about 5 inches. In some embodiments, the thickness of the Si substrate is about 3 inches to about 4 inches.

In some embodiments, the oxide is deposited onto the Si substrate using chemical vapor deposition. In some embodiments, the oxide is deposited onto the Si substrate using plasma enhanced chemical vapor deposition (PECVD).

In some embodiments, the oxide deposited onto the Si substrate is an inorganic oxide. Exemplary oxides include, but are not limited to, Si oxides, aluminum oxides, phosphorus oxides, and oligomeric and polymeric variants thereof.

In some embodiments, the thickness of the layer of oxide is about 0.1 μm to about 10 μm. In some embodiments, the thickness of the layer of oxide is about 0.1 μm to about 9 μm. In some embodiments, the thickness of the layer of oxide is about 0.1 μm to about 8 μm. In some embodiments, the thickness of the layer of oxide is about 0.1 μm to about 7 μm. In some embodiments, the thickness of the layer of oxide is about 0.1 μm to about 6 μm. In some embodiments, the thickness of the layer of oxide is about 0.1 μm to about 5 μm. In some embodiments, the thickness of the layer of oxide is about 0.1 μm to about 4 μm. In some embodiments, the thickness of the layer of oxide is about 0.1 μm to about 3 μm. In some embodiments, the thickness of the layer of oxide is about 0.1 μm to about 2 μm. In some embodiments, the thickness of the layer of oxide is about 0.1 μm to about 1 μm. In some embodiments, the thickness of the layer of oxide is about 1 μm to about 10 μm. In some embodiments, the thickness of the layer of oxide is about 1 μm to about 9 μm. In some embodiments, the thickness of the layer of oxide is about 1 μm to about 8 μm. In some embodiments, the thickness of the layer of oxide is about 1 μm to about 7 μm. In some embodiments, the thickness of the layer of oxide is about 1 μm to about 6 μm. In some embodiments, the thickness of the layer of oxide is about 1 μm to about 5 μm. In some embodiments, the thickness of the layer of oxide is about 1 μm to about 4 μm. In some embodiments, the thickness of the layer of oxide is about 1 μm to about 3 μm. In some embodiments, the thickness of the layer of oxide is about 1 μm to about 2 μm. In some embodiments, the thickness of the layer of oxide is about 2 μm to about 9 μm. In some embodiments, the thickness of the layer of oxide is about 2 μm to about 8 μm. In some embodiments, the thickness of the layer of oxide is about 2 μm to about 7 μm. In some embodiments, the thickness of the layer of oxide is about 2 μm to about 6 μm. In some embodiments, the thickness of the layer of oxide is about 2 μm to about 5 μm. In some embodiments, the thickness of the layer of oxide is about 2 μm to about 4 μm. In some embodiments, the thickness of the layer of oxide is about 2 μm to about 3 μm.

In some embodiments, a layer of photoresist is spin coated onto the oxide layer. In some embodiments, the substrate is further exposed to a photomask. In some embodiments, the substrate is further exposed to a resist developer. In some embodiments, the substrate is further etched using reactive ion etching. In some embodiments, the wafer is etched using deep reactive ion etching. In some embodiments, only the oxide layer is etched. In some embodiments, both the oxide layer and the Si layer are etched.

In some embodiments, the wafer is etched to generate at least one pillar. In some embodiments, the at least one pillar is distributed randomly across the wafer. In some embodiments, the at least one pillar is distributed in a pattern across the wafer.

In some embodiments, the wafer is etched to generate a plurality of pillars. In some embodiments, the plurality of pillars are uniform in size. In some embodiments, the plurality of pillars are about the same height.

In some embodiments, the height of the at least one pillar is about 1 μm to about 1000 μm. In some embodiments, the height of the at least one pillar is about 1 μm to about 900 μm. In some embodiments, the height of the at least one pillar is about 1 μm to about 800 μm. In some embodiments, the height of the at least one pillar is about 1 μm to about 700 μm. In some embodiments, the height of the at least one pillar is about 1 μm to about 600 μm. In some embodiments, the height of the at least one pillar is about 1 μm to about 500 μm. In some embodiments, the height of the at least one pillar is about 1 μm to about 400 μm. In some embodiments, the height of the at least one pillar is about 1 μm to about 300 μm. In some embodiments, the height of the at least one pillar is about 1 μm to about 200 μm. In some embodiments, the height of the at least one pillar is about 1 μm to about 100 μm. In some embodiments, the height of the at least one pillar is about 1 μm to about 90 μm. In some embodiments, the height of the at least one pillar is about 1 μm to about 80 μm. In some embodiments, the height of the at least one pillar is about 1 μm to about 70 μm. In some embodiments, the height of the at least one pillar is about 1 μm to about 60 μm. In some embodiments, the height of the at least one pillar is about 1 μm to about 50 μm. In some embodiments, the height of the at least one pillar is about 1 μm to about 40 μm. In some embodiments, the height of the at least one pillar is about 1 μm to about 30 μm. In some embodiments, the height of the at least one pillar is about 1 μm to about 20 μm. In some embodiments, the height of the at least one pillar is about 1 μm to about 10 μm. In some embodiments, the height of the at least one pillar is about 100 μm to about 1000 μm. In some embodiments, the height of the at least one pillar is about 100 μm to about 900 μm. In some embodiments, the height of the at least one pillar is about 100 μm to about 800 μm. In some embodiments, the height of the at least one pillar is about 100 μm to about 700 μm. In some embodiments, the height of the at least one pillar is about 100 μm to about 600 μm. In some embodiments, the height of the at least one pillar is about 100 μm to about 500 μm. In some embodiments, the height of the at least one pillar is about 100 μm to about 400 μm. In some embodiments, the height of the at least one pillar is about 100 μm to about 300 μm. In some embodiments, the height of the at least one pillar is about 100 μm to about 200 μm. In some embodiments, the height of the at least one pillar is about 200 μm to about 1000 μm. In some embodiments, the height of the at least one pillar is about 200 μm to about 900 μm. In some embodiments, the height of the at least one pillar is about 200 μm to about 800 μm. In some embodiments, the height of the at least one pillar is about 200 μm to about 700 μm. In some embodiments, the height of the at least one pillar is about 200 μm to about 600 μm. In some embodiments, the height of the at least one pillar is about 200 μm to about 500 μm. In some embodiments, the height of the at least one pillar is about 200 μm to about 400 μm. In some embodiments, the height of the at least one pillar is about 200 μm to about 300 μm. In some embodiments, the average height of the plurality of pillars is at least about 1 μm, 100 μm, 200 μm, 300 μm, 400 μm, 500 μm, 600 μm, 700 μm, 800 μm, 900 μm, or 1000 μm.

In some embodiments, the at least one pillar has an aspect ratio of about 1:1 to about 1:100. In some embodiments, the at least one pillar has an aspect ratio of about 1:1 to about 1:90. In some embodiments, the at least one pillar has an aspect ratio of about 1:1 to about 1:80. In some embodiments, the at least one pillar has an aspect ratio of about 1:1 to about 1:70. In some embodiments, the at least one pillar has an aspect ratio of about 1:1 to about 1:60. In some embodiments, the at least one pillar has an aspect ratio of about 1:1 to about 1:50. In some embodiments, the at least one pillar has an aspect ratio of about 1:1 to about 1:40. In some embodiments, the at least one pillar has an aspect ratio of about 1:1 to about 1:30. In some embodiments, the at least one pillar has an aspect ratio of about 1:1 to about 1:25. In some embodiments, the at least one pillar has an aspect ratio of about 1:1 to about 1:20. In some embodiments, the at least one pillar has an aspect ratio of about 1:1 to about 1:15. In some embodiments, the at least one pillar has an aspect ratio of about 1:1 to about 1:10. In some embodiments, the at least one pillar has an aspect ratio of about 1:10 to about 1:100. In some embodiments, the at least one pillar has an aspect ratio of about 1:10 to about 1:90. In some embodiments, the at least one pillar has an aspect ratio of about 1:10 to about 1:80. In some embodiments, the at least one pillar has an aspect ratio of about 1:10 to about 1:70. In some embodiments, the at least one pillar has an aspect ratio of about 1:10 to about 1:60. In some embodiments, the at least one pillar has an aspect ratio of about 1:10 to about 1:50. In some embodiments, the at least one pillar has an aspect ratio of about 1:10 to about 1:40. In some embodiments, the at least one pillar has an aspect ratio of about 1:10 to about 1:30. In some embodiments, the at least one pillar has an aspect ratio of about 1:10 to about 1:25. In some embodiments, the at least one pillar has an aspect ratio of about 1:10 to about 1:20. In some embodiments, the at least one pillar has an aspect ratio of about 1:10 to about 1:15. In some embodiments, the at least one pillar has an aspect ratio of at least about 1:1, 1:10, 1:15, 1:20, 1:25, 1:30, 1:40, 1:50, 1:60, 1:70, 1:80, 1:90, or 1:100.

In some embodiments, the polymeric material is put onto the master template using spin coating. In some embodiments, the polymeric material is an elastomer. In some embodiments, the polymeric material is a thermoplastic. In some embodiments, the polymeric material is a thermoplastic elastomer. Exemplary polymeric materials include, but are not limited to, a polyisoprene, polybutadiene, polysiloxane, polyacrylate, polysulfide, polystyrene, polyacrylonitrile, halogenated elastomer, perhalogenated elastomer, polyether, polyamide, and combinations or copolymers thereof. In some embodiments, the polymeric material comprises Si. In some embodiments, the polymeric material comprises polydimethylsiloxane.

In some embodiments, the step of releasing the template from the master mold is done manually. In some embodiments, the step of releasing the template from the master mold is done using a tool. In some embodiments, the step of releasing the template from the master mold is done by soaking the material in a solution. In some embodiments, the solution is organic. In some embodiments, the solution is aqueous. In some embodiments, the solution is a mixture of organic and aqueous solutions. In some embodiments, the step of releasing the template from the master mold is done without manual assistance.

In some embodiments, the polymeric material is an elastomer. In some embodiments, the polymeric material is a thermoplastic. In some embodiments, the polymeric material is a thermoplastic elastomer. In some embodiments, the polymeric material comprises Si. In some embodiments, the polymeric material comprises polydimethylsiloxane.

Other exemplary polymeric materials include, but are not limited to, a polyisoprene, polybutadiene, polysiloxane, polyacrylate, polysulfide, polystyrene, polyacrylonitrile, halogenated elastomer, perhalogenated elastomer, polyether, polyamide, and combinations or copolymers thereof.

In some embodiments, the polymeric material is cured on the master template for about 1 minute to about 1 hour. In some embodiments, the polymeric material is cured on the master template for about 10 minutes to about 1 hour. In some embodiments, the polymeric material is cured on the master template for about 30 minutes to about 1 hour. In some embodiments, the polymeric material is cured on the master template for about 1 minute to about 96 hours. In some embodiments, the polymeric material is cured on the master template for about 1 hour to about 96 hours. In some embodiments, the polymeric material is cured on the master template for about 1 hour to about 72 hours. In some embodiments, the polymeric material is cured on the master template for about 24 hours to about 72 hours. In some embodiments, the polymeric material is cured on the master template for about 24 hours to about 48 hours. In some embodiments, the polymeric material is cured on the master template for about 1 hour to about 48 hours. In some embodiments, the polymeric material is cured on the master template for at least about 1 minute, 10 minutes, 30 minutes, 1 hour, 24 hours, 48 hours, 72 hours, or 96 hours.

In some embodiments, the polymeric material is released from the master template. In some embodiments, the polymeric material is released from the master template manually. In some embodiments, the polymeric material is released from the master template using a tool. In some embodiments, the polymeric material is released from the master template by soaking the material in a solution. In some embodiments, the solution is organic. In some embodiments, the solution is aqueous. In some embodiments, the solution is a mixture of organic and aqueous solutions. In some embodiments, the polymeric material is released from the master template without manual assistance.

In one aspect, the present invention provides a method of fabricating a template for the synthesis of at least one microstructure having a controlled geometry, comprising the steps of: providing a polymer film; and drilling a plurality of holes into the polymer film. In some embodiments, the microstructure is a wire, a microwire, a nanowire, or a filament. The polymeric material used for the method is described elsewhere herein.

In some embodiments, the step of drilling is performed using a laser. In some embodiments, the laser has a wavelength of at most about 100 nm, 110 nm, 120 nm, 130 nm, 140 nm, 150 nm, 160 nm, 170 nm, 180 nm, 190 nm, or 200 nm. In some embodiments, the laser has a wavelength of about 190 nm. In some embodiments, the laser has a power of at least about 5 J/cm², 10 J/cm², 15 J/cm², 20 J/cm², 25 J/cm², 30 J/cm², 35 J/cm², 40 J/cm², or 45 J/cm². In some embodiments, the holes are rectangular prisms. In some embodiments, the holes are symmetrical. In some embodiments, the holes are cylindrical. In some embodiments, the holes have an average width or diameter between at least about 5 μm to about 60 μm, 10 μm to about 60 μm, 15 μm to about 60 μm, 20 μm to about 60 μm, 25 μm to about 60 μm, 30 μm to about 60 μm, 35 μm to about 60 μm, 40 μm to about 60 μm, 45 μm to about 60 μm, 50 μm to about 60 μm, 55 μm to about 60 μm, 5 μm to about 50 μm, 5 μm to about 40 μm, 5 μm to about 30 μm, 5 μm to about 20 μm, 5 μm to about 15 μm, or 5 μm to about 10 μm. In some embodiments, the holes have an average width of at least about 5 μm, 10 μm, 15 μm, 20 μm, 25 μm, 30 μm, 35 μm, 40 μm, 45 μm, 50 μm, 55 μm, or 60 μm.

In some embodiments, the holes have an average spacing between at least about 5 μm to about 60 μm, 10 μm to about 60 μm, 15 μm to about 60 μm, 20 μm to about 60 μm, 25 μm to about 60 μm, 30 μm to about 60 μm, 35 μm to about 60 μm, 40 μm to about 60 μm, 45 μm to about 60 μm, 50 μm to about 60 μm, 55 μm to about 60 μm, 5 μm to about 50 μm, 5 μm to about 40 μm, 5 μm to about 30 μm, 5 μm to about 20 μm, 5 μm to about 15 μm, or 5 μm to about 10 μm. In some embodiments, the holes have an average spacing of at least about 5 μm, 10 μm, 15 μm, 20 μm, 25 μm, 30 μm, 35 μm, 40 μm, 45 μm, 50 μm, 55 μm, or 60 μm.

In some embodiments, the holes have an average depth or height of at least about 1 μm to about 1000 μm, 1 μm to about 900 μm, 1 μm to about 800 μm, 1 μm to about 700 μm, 1 μm to about 600 μm, 1 μm to about 500 μm, 1 μm to about 400 μm, 1 μm to about 300 μm, 1 μm to about 200 μm, or 1 μm to about 100 μm. In some embodiments, the holes have an average depth or height of at least about 1 μm, 100 μm, 200 μm, 300 μm, 400 μm, 500 μm, 600 μm, 700 μm, 800 μm, 900 μm, or 1000 μm.

### Templates

In one aspect, the present invention provides a template for the synthesis of at least one microstructure having a controlled geometry. In one aspect, the present invention provides a template for the synthesis of at least one microstructure of the present invention.

In some embodiments, the template is flexible. In some embodiments, the template is rigid. In some embodiments, the template is transparent. In some embodiments, the template is opaque. In some embodiments, the template is any template described herein.

In some embodiments, the template comprises a polymeric material. In some embodiments, the polymeric material is an elastomer. In some embodiments, the polymeric material is a thermoplastic. In some embodiments, the polymeric material is a thermoplastic elastomer. Exemplary polymeric materials include, but are not limited to, a polyisoprene, polybutadiene, polysiloxane, polyacrylate, polysulfide, polystyrene, polyacrylonitrile, halogenated elastomer, perhalogenated elastomer, polyether, polyamide, and combinations or copolymers thereof. In some embodiments, the polymeric material comprises Si. In some embodiments, the polymeric material comprises polydimethylsiloxane.

In some embodiments, the template has a thickness of about 1 μm to about 1000 μm. In some embodiments, the template has a thickness of about 1 μm to about 900 μm. In some embodiments, the template has a thickness of about 1 μm to about 800 μm. In some embodiments, the template has a thickness of about 1 μm to about 700 μm. In some embodiments, the template has a thickness of about 1 μm to about 600 μm. In some embodiments, the template has a thickness of about 1 μm to about 500 μm. In some embodiments, the template has a thickness of about 1 μm to about 400 μm. In some embodiments, the template has a thickness of about 1 μm to about 300 μm. In some embodiments, the template has a thickness of about 1 μm to about 200 μm. In some embodiments, the template has a thickness of about 1 μm to about 100 μm. In some embodiments, the template has a thickness of about 100 μm to about 1000 μm. In some embodiments, the template has a thickness of about 100 μm to about 900 μm. In some embodiments, the template has a thickness of about 100 μm to about 800 μm. In some embodiments, the template has a thickness of about 100 μm to about 700 μm. In some embodiments, the template has a thickness of about 100 μm to about 600 μm. In some embodiments, the template has a thickness of about 100 μm to about 500 μm. In some embodiments, the template has a thickness of about 100 μm to about 400 μm. In some embodiments, the template has a thickness of about 100 μm to about 300 μm. In some embodiments, the template has a thickness of about 100 μm to about 200 μm. In some embodiments, the template has a thickness of about 10 μm to about 100 μm. In some embodiments, the template has a thickness of about 20 μm to about 100 μm. In some embodiments, the template has a thickness of about 30 μm to about 100 μm. In some embodiments, the template has a thickness of about 40 μm to about 100 μm. In some embodiments, the template has a thickness of about 50 μm to about 100 μm. In some embodiments, the template has a thickness of about 60 μm to about 100 μm. In some embodiments, the template has a thickness of about 70 μm to about 100 μm. In some embodiments, the template has a thickness of about 80 μm to about 100 μm. In some embodiments, the template has a thickness of about 90 μm to about 100 μm. In some embodiments, the template has a thickness of at least about 1 μm, 10 μm, 20 μm, 30 μm, 40 μm, 50 μm, 60 μm, 70 μm, 80 μm, 90 μm, or 100 μm.

In some embodiments, the template comprises at least one pore. In some embodiments, the at least one pore has a depth of about 1 μm to about 1000 μm. In some embodiments, the at least one pore has a depth of about 1 μm to about 900 μm. In some embodiments, the at least one pore has a depth of about 1 μm to about 800 μm. In some embodiments, the at least one pore has a depth of about 1 μm to about 700 μm. In some embodiments, the at least one pore has a depth of about 1 μm to about 600 μm. In some embodiments, the at least one pore has a depth of about 1 μm to about 500 μm. In some embodiments, the at least one pore has a depth of about 1 μm to about 400 μm. In some embodiments, the at least one pore has a depth of about 1 μm to about 300 μm. In some embodiments, the at least one pore has a depth of about 1 μm to about 200 μm. In some embodiments, the at least one pore has a depth of about 1 μm to about 100 μm. In some embodiments, the at least one pore has a depth of about 100 μm to about 1000 μm. In some embodiments, the at least one pore has a depth of about 100 μm to about 900 μm. In some embodiments, the at least one pore has a depth of about 100 μm to about 800 μm. In some embodiments, the at least one pore has a depth of about 100 μm to about 700 μm. In some embodiments, the at least one pore has a depth of about 100 μm to about 600 μm. In some embodiments, the at least one pore has a depth of about 100 μm to about 500 μm. In some embodiments, the at least one pore has a depth of about 100 μm to about 400 μm. In some embodiments, the at least one pore has a depth of about 100 μm to about 300 μm. In some embodiments, the at least one pore has a depth of about 100 μm to about 200 μm. In some embodiments, the at least one pore has a depth of about 10 μm to about 100 μm. In some embodiments, the at least one pore has a depth of about 20 μm to about 100 μm. In some embodiments, the at least one pore has a depth of about 30 μm to about 100 μm. In some embodiments, the at least one pore has a depth of about 40 μm to about 100 μm. In some embodiments, the at least one pore has a depth of about 50 μm to about 100 μm. In some embodiments, the at least one pore has a depth of about 60 μm to about 100 μm. In some embodiments, the at least one pore has a depth of about 70 μm to about 100 μm. In some embodiments, the at least one pore has a depth of about 80 μm to about 100 μm. In some embodiments, the at least one pore has a depth of about 90 μm to about 100 μm. In some embodiments, the at least one pore has a depth of at least about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm.

In some embodiments, the template comprises a plurality of pores. In some embodiments, the plurality of pores has an average depth of about 1 μm to about 1000 μm. In some embodiments, the plurality of pores has an average depth of about 1 μm to about 900 μm. In some embodiments, the plurality of pores has an average depth of about 1 μm to about 800 μm. In some embodiments, the plurality of pores has an average depth of about 1 μm to about 700 μm. In some embodiments, the plurality of pores has an average depth of about 1 μm to about 600 μm. In some embodiments, the plurality of pores has an average depth of about 1 μm to about 500 μm. In some embodiments, the plurality of pores has an average depth of about 1 μm to about 400 μm. In some embodiments, the plurality of pores has an average depth of about 1 μm to about 300 μm. In some embodiments, the plurality of pores has an average depth of about 1 μm to about 200 μm. In some embodiments, the plurality of pores has an average depth of about 1 μm to about 100 μm. In some embodiments, the plurality of pores has an average depth of about 100 μm to about 1000 μm. In some embodiments, the plurality of pores has an average depth of about 100 μm to about 900 μm. In some embodiments, the plurality of pores has an average depth of about 100 μm to about 800 μm. In some embodiments, the plurality of pores has an average depth of about 100 μm to about 700 μm. In some embodiments, the plurality of pores has an average depth of about 100 μm to about 600 μm. In some embodiments, the plurality of pores has an average depth of about 100 μm to about 500 μm. In some embodiments, the plurality of pores has an average depth of about 100 μm to about 400 μm. In some embodiments, the plurality of pores has an average depth of about 100 μm to about 300 μm. In some embodiments, the plurality of pores has an average depth of about 100 μm to about 200 μm. In some embodiments, the plurality of pores has an average depth of about 10 μm to about 100 μm. In some embodiments, the plurality of pores has an average depth of about 20 μm to about 100 μm. In some embodiments, the plurality of pores has an average depth of about 30 μm to about 100 μm. In some embodiments, the plurality of pores has an average depth of about 40 μm to about 100 μm. In some embodiments, the plurality of pores has an average depth of about 50 μm to about 100 μm. In some embodiments, the plurality of pores has an average depth of about 60 μm to about 100 μm. In some embodiments, the plurality of pores has an average depth of about 70 μm to about 100 μm. In some embodiments, the plurality of pores has an average depth of about 80 μm to about 100 μm. In some embodiments, the plurality of pores has an average depth of about 90 μm to about 100 μm. In some embodiments, the plurality of pores has an average depth of at least about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm.

In some embodiments, the template has a shear storage modulus (G′) between about 100 Pa to about 10,000 Pa. In some embodiments, the template has a shear storage modulus (G′) between about 100 Pa to about 5,000 Pa. In some embodiments, the template has a shear storage modulus (G′) between about 100 Pa to about 2,000 Pa. In some embodiments, the template has a shear storage modulus (G′) between about 100 Pa to about 1,500 Pa. In some embodiments, the template has a shear storage modulus (G′) between about 100 Pa to about 1,200 Pa. In some embodiments, the template has a shear storage modulus (G′) between about 100 Pa to about 1,000 Pa. In some embodiments, the template has a shear storage modulus (G′) between about 200 Pa to about 1,000 Pa. In some embodiments, the template has a shear storage modulus (G′) between about 250 Pa to about 900 Pa. For example, in some embodiments, the template has a shear storage modulus (G′) between about 100 Pa to about 2,000 Pa.

In some embodiments, the template has a shear loss modulus (G″) between about 1 Pa to about 100 Pa. In some embodiments, the template has a shear loss modulus (G″) between about 1 Pa to about 50 Pa. In some embodiments, the template has a shear loss modulus (G″) between about 10 Pa to about 50 Pa. In some embodiments, the template has a shear loss modulus (G″) between about 20 Pa to about 50 Pa. In some embodiments, the template has a shear loss modulus (G″) between about 30 Pa to about 50 Pa. In some embodiments, the template has a shear loss modulus (G″) between about 40 Pa to about 50 Pa. In some embodiments, the template has a shear loss modulus (G″) between about 1 Pa to about 10 Pa. In some embodiments, the template has a shear loss modulus (G″) between about 1 Pa to about 30 Pa. For example, in some embodiments, the template has a shear loss modulus (G″) between about 1 Pa to about 50 Pa.

In some embodiments, the template has a tan δ, determined using shear theory at 1 Hz (or 2 pi), between about 0.01 to about 0.7. In some embodiments, the template has a tan δ, determined using shear theory at 1 Hz (or 2 pi), between about 0.1 to about 0.7. In some embodiments, the template has a tan δ, determined using shear theory at 1 Hz (or 2 pi), between about 0.1 to about 0.6. In some embodiments, the template has a tan δ, determined using shear theory at 1 Hz (or 2 pi), between about 0.1 to about 0.5. In some embodiments, the template has a tan δ, determined using shear theory at 1 Hz (or 2 pi), between about 0.1 to about 0.45. In some embodiments, the template has a tan δ, determined using shear theory at 1 Hz (or 2 pi), between about 0.2 to about 0.45. In some embodiments, the template has a tan δ, determined using shear theory at 1 Hz (or 2 pi), between about 0.25 to about 0.45. In some embodiments, the template has a tan δ, determined using shear theory at 1 Hz (or 2 pi), between about 0.3 to about 0.45. In some embodiments, the template has a tan δ, determined using shear theory at 1 Hz (or 2 pi), between about 0.3 to about 0.45. In some embodiments, the template has a tan δ, determined using shear theory at 1 Hz (or 2 pi), between about 0.01 to about 0.3. In some embodiments, the template has a tan δ, determined using shear theory at 1 Hz (or 2 pi), between about 0.01 to about 0.1. In some embodiments, the template has a tan δ, determined using shear theory at 1 Hz (or 2 pi), between about 0.01 to about 0.07. In some embodiments, the template has a tan δ, determined using shear theory at 1 Hz (or 2 pi), between about 0.01 to about 0.06. In some embodiments, the template has a tan δ, determined using shear theory at 1 Hz (or 2 pi), between about 0.01 to about 0.05. In some embodiments, the template has a tan δ, determined using shear theory at 1 Hz (or 2 pi), between about 0.01 to about 0.045. In some embodiments, the template has a tan δ, determined using shear theory at 1 Hz (or 2 pi), between about 0.02 to about 0.045. In some embodiments, the template has a tan δ, determined using shear theory at 1 Hz (or 2 pi), between about 0.025 to about 0.045. For example, in some embodiments, the template has a tan δ, determined using shear theory at 1 Hz (or 2 pi), between about 0.03 to about 0.045.

### Methods of Fabricating Microstructures

The present invention is further drawn to a method of fabricating at least one microstructure having a controlled geometry. In one aspect, the present invention is drawn to a method of fabricating at least one microstructure of the present invention. In one aspect, the present invention is drawn to a method of fabricating a plurality of microstructures. In one aspect, the present invention is drawn to a method of fabricating a template for the synthesis of microstructures.

In some embodiments, the present invention provides a method of making a microstructure, the method comprising the steps of: providing a template comprising a plurality of pores having an average depth of 100 μm to 1000 μm, attaching the template to a substrate, exposing the template to a solution comprising a metal precursor, and reducing the metal precursor, thereby growing the microstructure on the template.

In some embodiments, the substrate is a flat surface. In some embodiments, the substrate is a curved surface. In some embodiments, the method further comprises the step of attaching the template to at least a portion of the surface of the substrate. In some embodiments, the surface of the substrate comprises a flat surface, a curved surface, or a combination thereof. In some embodiments, the substrate is metal. Exemplary metals include, but are not limited to, titanium, manganese, iron, cobalt, nickel, copper, zinc, silver, platinum, gold, gallium, indium, tin, lead, salts thereof, and any combination thereof. In some embodiments, the substrate is a polymer. Exemplary polymers include, but are not limited to, a polyethylene, a polyamide, a polycarbonate, a polystyrene, a halopolymer, a polyester, an epoxy, a polybenzazole, and copolymers thereof. In some embodiments, the substrate is a ceramic.

In some embodiments, the metal precursor is a metal salt. As used herein, the term “metal precursor” is used interchangeably with the term “metal salt”. In some embodiments, the metal precursor comprises a metal ion. Exemplary metals of the metal salt or metal precursor include, but are not limited to, lithium, sodium, potassium, calcium, scandium, titanium, vanadium, chromium, manganese, iron, cobalt, nickel, copper, zinc, molybdenum, ruthenium, rhodium, palladium, silver, tungsten, iridium, platinum, gold, aluminum, gallium, indium, ions thereof, any oxidation state thereof, and combinations thereof. In some embodiments, the metal precursor comprises copper. In some embodiments, the metal precursor comprises copper (I). In some embodiments, the metal precursor comprises copper (II).

In some embodiments, the metal salt comprises an organic counterion. In some embodiments, the metal salt comprises an inorganic counterion. Exemplary counterions include, but are not limited to, halides, borates, phosphates, carbonates, oxides, perchlorates, nitrates, and sulfates. In some embodiments, the metal precursor comprises copper sulfate.

In some embodiments, the solution comprising a metal precursor further comprises an acid. Exemplary acids include, but are not limited to, HF, HCl, HBr, HI, H₂SO₄, HNO₃, HClO₄ and HClO₃.

In some embodiments, the solution comprising a metal precursor comprises the precursor in a concentration of about 0.01 M to about 5.0 M. In some embodiments, the solution comprising a metal precursor comprises the precursor in a concentration of about 0.1 M to about 5.0 M. In some embodiments, the solution comprising a metal precursor comprises the precursor in a concentration of about 0.1 M to about 4.0 M. In some embodiments, the solution comprising a metal precursor comprises the precursor in a concentration of about 0.1 M to about 3.0 M. In some embodiments, the solution comprising a metal precursor comprises the precursor in a concentration of about 0.1 M to about 2.0 M. In some embodiments, the solution comprising a metal precursor comprises the precursor in a concentration of about 0.1 M to about 1.0 M. In some embodiments, the solution comprising a metal precursor comprises the precursor in a concentration of about 0.2 M to about 1.0 M. In some embodiments, the solution comprising a metal precursor comprises the precursor in a concentration of about 0.3 M to about 1.0 M. In some embodiments, the solution comprising a metal precursor comprises the precursor in a concentration of about 0.4 M to about 1.0 M. In some embodiments, the solution comprising a metal precursor comprises the precursor in a concentration of about 0.5 M to about 1.0 M. In some embodiments, the solution comprising a metal precursor comprises the precursor in a concentration of about 0.6 M to about 1.0 M. In some embodiments, the solution comprising a metal precursor comprises the precursor in a concentration of about 0.7 M to about 1.0 M. In some embodiments, the solution comprising a metal precursor comprises the precursor in a concentration of about 0.8 M to about 1.0 M. In some embodiments, the solution comprising a metal precursor comprises the precursor in a concentration of about 0.9 M to about 1.0 M.

In some embodiments, reducing the metal precursor results in electrodeposition. In some embodiments, reducing the metal precursor results in electroplating. The term “electrodeposition” refers to electroplating processes, in which the deposited metal or alloy adheres to the substrate surface, and to electroforming processes, in which the deposited metal or alloy is detached from the substrate surface after it is deposited.

In some embodiments, reducing the metal precursor is performed by supplying a constant voltage to the solution. In some embodiments, the step of reducing the metal precursor is performed by supplying a constant voltage to the solution having a magnitude of less than about 0.1 V, about 0.1 V to about 1.0 V, about 0.2 V to about 1.0 V, about 0.3 V to about 1.0 V, about 0.4 V to about 1.0 V, about 0.5 V to about 1.0 V, about 0.6 V to about 1.0 V, about 0.7 V to about 1.0 V, about 0.8 V to about 1.0 V, about 0.9 V to about 1.0 V, or at least about 1.0 V. In some embodiments, the voltage supplied has a magnitude of at least about 0.1 V, 0.2 V, 0.3 V, 0.4 V, 0.5 V, 0.6 V, 0.7 V, 0.8 V, 0.9 V, or 1.0 V. In some embodiments, the voltage is negative. In some embodiments, the voltage is about −0.4 V.

In some embodiments, the solution comprises a polar solvent. Examples of such polar solvents include, but are not limited to, water, glycerin, propylene glycol, ethylene glycol, tetraethylene glycol, triethylene glycol, trimethylene glycol, acetone, acetonitrile, dimethylformamide, dimethylsulfoxide, isopropanol, methanol, ethanol, tetrahydrofuran, formic acid, nitromethane, and combinations thereof.

In some embodiments, the solution comprises a non-polar solvent. Examples of such non-polar solvents include, but are not limited to, alkanes, including but not limited to cycloalkanes, propane, pentane, hexane, and heptane, benzene, toluene, xylene, chloroform, diethyl ether, ethyl acetate, dichloromethane, toluene, and combinations thereof.

In some embodiments, the solution is an acidic solution. In another embodiment, the solution is a basic solution. In another embodiment, the solution is a neutral solution.

In some embodiments, the pH of the solution is from about 1 to about 14. In some embodiments, the pH of the solution is from about 1 to about 13. In some embodiments, the pH of the solution is from about 1 to about 12. In some embodiments, the pH of the solution is from about 1 to about 10. In some embodiments, the pH of the solution is from about 1 to about 9. In some embodiments, the pH of the solution is from about 1 to about 8. In some embodiments, the pH of the solution is from about 1 to about 7. In some embodiments, the pH of the solution is from about 1 to about 6. In some embodiments, the pH of the solution is from about 1 to about 5. In some embodiments, the pH of the solution is from about 1 to about 4. In some embodiments, the pH of the solution is from about 1 to about 3. In some embodiments, the pH of the solution is from about 1 to about 2. In some embodiments, the pH of the solution is at least about 1, 2, 3, 4, 5, 6, 7, 8, 9, 10, 11, 12, 13, or 14.

In some embodiments, the solution is organic. In some embodiments, the solution is aqueous. In some embodiments, the solution is a mixture of organic and aqueous solutions.

In some embodiments, the microstructure is released from the template without manual assistance.

In some embodiments, the microstructure is rod-shaped. In some embodiments, the microstructure is a wire. In some embodiments, the microstructure is a microwire. In some embodiments, the microstructure is a nanowire. In some embodiments, the microstructure is a nanotube. In some embodiments, the microstructure is cylindrical. In some embodiments, the microstructure is irregular. In some embodiments, the microstructure is crystalline. Any other embodiment drawn to a microstructure throughout the present disclosure is applicable to the at least microstructure described herein.

In some embodiments, the microstructure has an aspect ratio of about 1:1 to about 1:100. In some embodiments, the microstructure has an aspect ratio of about 1:1 to about 1:90. In some embodiments, the microstructure has an aspect ratio of about 1:1 to about 1:80. In some embodiments, the microstructure has an aspect ratio of about 1:1 to about 1:70. In some embodiments, the microstructure has an aspect ratio of about 1:1 to about 1:60. In some embodiments, the microstructure has an aspect ratio of about 1:1 to about 1:50. In some embodiments, the microstructure has an aspect ratio of about 1:1 to about 1:40. In some embodiments, the microstructure has an aspect ratio of about 1:1 to about 1:30. In some embodiments, the microstructure has an aspect ratio of about 1:1 to about 1:25. In some embodiments, the microstructure has an aspect ratio of about 1:1 to about 1:20. In some embodiments, the microstructure has an aspect ratio of about 1:1 to about 1:15. In some embodiments, the microstructure has an aspect ratio of about 1:1 to about 1:10. In some embodiments, the microstructure has an aspect ratio of about 1:10 to about 1:100. In some embodiments, the microstructure has an aspect ratio of about 1:10 to about 1:90. In some embodiments, the microstructure has an aspect ratio of about 1:10 to about 1:80. In some embodiments, the microstructure has an aspect ratio of about 1:10 to about 1:70. In some embodiments, the microstructure has an aspect ratio of about 1:10 to about 1:60. In some embodiments, the microstructure has an aspect ratio of about 1:10 to about 1:50. In some embodiments, the microstructure has an aspect ratio of about 1:10 to about 1:40. In some embodiments, the microstructure has an aspect ratio of about 1:10 to about 1:30. In some embodiments, the microstructure has an aspect ratio of about 1:10 to about 1:25. In some embodiments, the microstructure has an aspect ratio of about 1:10 to about 1:20. In some embodiments, the microstructure has an aspect ratio of about 1:10 to about 1:15. In some embodiments, the microstructure has an aspect ratio of at least about 1:1, 1:10, 1:15, 1:20, 1:25, 1:30, 1:40, 1:50, 1:60, 1:70, 1:80, 1:90, or 1:100.

In some embodiments, the length of the microstructure is about 1 μm to about 1000 μm. In some embodiments, the length of the microstructure is about 1 μm to about 900 μm.

In some embodiments, the length of the microstructure is about 1 μm to about 800 μm. In some embodiments, the length of the microstructure is about 1 μm to about 700 μm. In some embodiments, the length of the microstructure is about 1 μm to about 600 μm. In some embodiments, the length of the microstructure is about 1 μm to about 500 μm. In some embodiments, the length of the microstructure is about 1 μm to about 400 μm. In some embodiments, the length of the microstructure is about 1 μm to about 300 μm. In some embodiments, the length of the microstructure is about 1 μm to about 200 μm. In some embodiments, the length of the microstructure is about 1 μm to about 100 μm. In some embodiments, the length of the microstructure is about 100 μm to about 1000 μm. In some embodiments, the length of the microstructure is about 100 μm to about 900 μm. In some embodiments, the length of the microstructure is about 100 μm to about 800 μm. In some embodiments, the length of the microstructure is about 100 μm to about 700 μm. In some embodiments, the length of the microstructure is about 100 μm to about 600 μm. In some embodiments, the length of the microstructure is about 100 μm to about 500 μm. In some embodiments, the length of the microstructure is about 100 μm to about 400 μm. In some embodiments, the length of the microstructure is about 100 μm to about 300 μm. In some embodiments, the length of the microstructure is about 100 μm to about 200 μm. In some embodiments, the length of the microstructure is about 10 μm to about 100 μm. In some embodiments, the length of the microstructure is about 20 μm to about 100 μm. In some embodiments, the length of the microstructure is about 30 μm to about 100 μm. In some embodiments, the length of the microstructure is about 40 μm to about 100 μm. In some embodiments, the length of the microstructure is about 50 μm to about 100 μm. In some embodiments, the length of the microstructure is about 60 μm to about 100 μm. In some embodiments, the length of the microstructure is about 70 μm to about 100 μm. In some embodiments, the length of the microstructure is about 80 μm to about 100 μm.

In some embodiments, the microstructure is released from the template. In some embodiments, the microstructure is released from the template manually. In some embodiments, the microstructure is released from the template using a tool. In some embodiments, the microstructure is released from the template by soaking the material in a solution.

The present invention is further drawn to a method of fabricating at least one microstructure, wherein the method comprises the steps of: providing any template of the present invention; exposing the template to a solution comprising a metal precursor; and reducing the metal precursor, thereby growing the at least one microstructure on the template.

### Microstructures and Nanostructures

The present invention is drawn, in part, microstructures and nanostructures created using a template provided herein. Unless stated otherwise, any embodiments describing “microstructures” are applicable as embodiments describing “nanostructures”, and vice versa. In some embodiments, the microstructure has a controlled geometry. In some embodiments, the microstructure having a controlled geometry is a wire. In some embodiments, the microstructure having a controlled geometry is a microwire. In some embodiments, the microstructure having a controlled geometry is a nanowire. In some embodiments, the microstructure having a controlled geometry is a filament.

In some embodiments, the microstructure comprises at least one metal. In some embodiments, the microstructure comprises at least one alloy. In some embodiments, the microstructure comprises at least one metal, at least one alloy comprising at least one metal, or a combination thereof. Exemplary metals include, but are not limited to, lithium, sodium, magnesium, potassium, calcium, scandium, titanium, vanadium, chromium, manganese, iron, cobalt, nickel, copper, zinc, molybdenum, ruthenium, rhodium, palladium, silver, tungsten, iridium, platinum, gold, aluminum, gallium, indium, tin, any alloys thereof, and any oxidation state thereof. For example, in some embodiments, the metal is copper. In some embodiments, the microstructure comprises a polymer.

In some embodiments, the microstructure is rod-shaped. In some embodiments, the microstructure is a wire. In some embodiments, the microstructure is a nanowire. In some embodiments, the microstructure is a nanotube. In some embodiments, the microstructure is cylindrical. In some embodiments, the microstructure has a circular cross-section. In some embodiments, the microstructure has an elliptical cross-section. In some embodiments, the microstructure has a cross-section with at least three sides. In some embodiments, the microstructure has a triangular cross-section. In some embodiments, the microstructure has a square cross-section. In some embodiments, the microstructure has a rectangular cross-section. In some embodiments, the microstructure has a pentagonal cross-section. In some embodiments, the microstructure has a hexagonal cross-section.

As used herein, “aspect ratio” describes the proportional relationship between the width or diameter of an object, herein a microstructure or nanostructure, and its length.

In some embodiments, the microstructure has an aspect ratio of about 1:1 to about 1:100. In some embodiments, the microstructure has an aspect ratio of about 1:1 to about 1:90. In some embodiments, the microstructure has an aspect ratio of about 1:1 to about 1:80. In some embodiments, the microstructure has an aspect ratio of about 1:1 to about 1:70. In some embodiments, the microstructure has an aspect ratio of about 1:1 to about 1:60. In some embodiments, the microstructure has an aspect ratio of about 1:1 to about 1:50. In some embodiments, the microstructure has an aspect ratio of about 1:1 to about 1:40. In some embodiments, the microstructure has an aspect ratio of about 1:1 to about 1:30. In some embodiments, the microstructure has an aspect ratio of about 1:1 to about 1:25. In some embodiments, the microstructure has an aspect ratio of about 1:1 to about 1:20. In some embodiments, the microstructure has an aspect ratio of about 1:1 to about 1:15. In some embodiments, the microstructure has an aspect ratio of about 1:1 to about 1:10. In some embodiments, the microstructure has an aspect ratio of about 1:5 to about 1:100. In some embodiments, the microstructure has an aspect ratio of about 1:5 to about 1:90. In some embodiments, the microstructure has an aspect ratio of about 1:5 to about 1:80. In some embodiments, the microstructure has an aspect ratio of about 1:5 to about 1:70. In some embodiments, the microstructure has an aspect ratio of about 1:5 to about 1:60. In some embodiments, the microstructure has an aspect ratio of about 1:5 to about 1:50. In some embodiments, the microstructure has an aspect ratio of about 1:5 to about 1:40. In some embodiments, the microstructure has an aspect ratio of about 1:5 to about 1:30. In some embodiments, the microstructure has an aspect ratio of about 1:5 to about 1:25. In some embodiments, the microstructure has an aspect ratio of about 1:5 to about 1:20. In some embodiments, the microstructure has an aspect ratio of about 1:5 to about 1:15. In some embodiments, the microstructure has an aspect ratio of about 1:5 to about 1:10. In some embodiments, the microstructure has an aspect ratio of about 1:10 to about 1:100. In some embodiments, the microstructure has an aspect ratio of about 1:10 to about 1:90. In some embodiments, the microstructure has an aspect ratio of about 1:10 to about 1:80. In some embodiments, the microstructure has an aspect ratio of about 1:10 to about 1:70. In some embodiments, the microstructure has an aspect ratio of about 1:10 to about 1:60. In some embodiments, the microstructure has an aspect ratio of about 1:10 to about 1:50. In some embodiments, the microstructure has an aspect ratio of about 1:10 to about 1:40. In some embodiments, the microstructure has an aspect ratio of about 1:10 to about 1:30. In some embodiments, the microstructure has an aspect ratio of about 1:10 to about 1:25. In some embodiments, the microstructure has an aspect ratio of about 1:10 to about 1:20. In some embodiments, the microstructure has an aspect ratio of about 1:10 to about 1:15.

In some embodiments, the length of the microstructure is about 1 μm to about 1000 μm. In some embodiments, the length of the microstructure is about 1 μm to about 900 μm. In some embodiments, the length of the microstructure is about 1 μm to about 800 μm. In some embodiments, the length of the microstructure is about 1 μm to about 700 μm. In some embodiments, the length of the microstructure is about 1 μm to about 600 μm. In some embodiments, the length of the microstructure is about 1 μm to about 500 μm. In some embodiments, the length of the microstructure is about 1 μm to about 400 μm. In some embodiments, the length of the microstructure is about 1 μm to about 300 μm. In some embodiments, the length of the microstructure is about 1 μm to about 200 μm. In some embodiments, the length of the microstructure is about 1 μm to about 100 μm. In some embodiments, the length of the microstructure is about 100 μm to about 1000 μm. In some embodiments, the length of the microstructure is about 100 μm to about 900 μm. In some embodiments, the length of the microstructure is about 100 μm to about 800 μm. In some embodiments, the length of the microstructure is about 100 μm to about 700 μm. In some embodiments, the length of the microstructure is about 100 μm to about 600 μm. In some embodiments, the length of the microstructure is about 100 μm to about 500 μm. In some embodiments, the length of the microstructure is about 100 μm to about 400 μm. In some embodiments, the length of the microstructure is about 100 μm to about 300 μm. In some embodiments, the length of the microstructure is about 100 μm to about 200 μm. In some embodiments, the length of the microstructure is about 10 μm to about 100 μm. In some embodiments, the length of the microstructure is about 20 μm to about 100 μm. In some embodiments, the length of the microstructure is about 30 μm to about 100 μm. In some embodiments, the length of the microstructure is about 40 μm to about 100 μm. In some embodiments, the length of the microstructure is about 50 μm to about 100 μm. In some embodiments, the length of the microstructure is about 60 μm to about 100 μm. In some embodiments, the length of the microstructure is about 70 μm to about 100 μm. In some embodiments, the length of the microstructure is about 80 μm to about 100 μm. In some embodiments, the length of the microstructure is about 90 μm to about 100 μm.

The present invention is further drawn to a microstructure prepared using a method comprising the steps of: providing a template comprising a polymeric material, exposing the template to a solution comprising at least one metal compound, growing the microstructures on the template, and removing the microstructure from the template.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the exemplary embodiments of the present invention, and are not to be construed as limiting in any way the remainder of the disclosure.

Polydimethylsiloxane (PDMS), a versatile soft polymer, has also been explored as a template material. The PDMS templates with aligned through holes were usually fabricated using a master mold. In this regard, molds of patterned photoresist columns arrays were prepared using photolithography processes (Tibbe et al., 2018, Nanoscale, 10, 7711; Zakharova et al., 2020, Lab on a Chip, 20, 3132). Then, a solution of PDMS mixed with hexane was spin-coated onto the mold. The next step involved plasma etching of the top layer of PDMS to open the through holes. Finally, the cured PDMS with through holes was released from the mold after dissolving the photoresist in acetone. However, the thickness of the prepared PDMS membrane is usually limited to several microns. Li et al. (Li et al., 2015, Biomaterials, 47, 51) fabricated 60 μm thick PDMS membranes with through holes using standard microfabrication methods by replica molding PDMS membrane from an SU-8 photoresist mold. In detail, they first prepared a mold of 60 μm tall SU-8 pillars array using the photolithography process. Then, a 1 μm thick Shipley S1805 photoresist was conformally coated on the mold as a sacrificial layer. Next, a PDMS solution was spin-coated onto the mold and cured. Finally, the free-standing PDMS template membrane was obtained after dissolving the S1805 in acetone.

The abovementioned templates all have limited thicknesses. Yet, some applications, such as microelectromechanical systems (MEMS), microscale electrodes, microscale sensing, require structures that are longer, reaching up to hundreds of microns. Thus, developing new methods to produce templates with greater thickness are necessary to broaden the application of 1D aligned structures. Also, robust mold material, such as a Si needs to be developed for molds with high aspect ratio pillars that can be reused.

For molds with pillars of very high aspect ratio, a big challenge lies in releasing the PDMS membrane from the mold due to the strong adhesion and friction between the cured PDMS and the mold. Walsh et al. (Walsh et al., 2001, IEEE International Conference on Micro Electromechanical Systems, 114) investigated a process of sacrificial photoresist layer dissolution in acetone in microchannels, which helped release the structures. Heyries et al. (Heyries, 2011, Lab on a Chip, 11, 4122) reported that the conformal Parylene C coating on an SU8 pillars master mold can facilitate PDMS release and protect the master mold, thereby extending its lifespan and improving the achievable density and aspect ratio of the pillars in the mold.

Instead of releasing the polymer template from a 1D structure array mold, an alternative approach is to directly etch away the mold. An et al. (An et al., 2015, Materials Letters, 149, 109) prepared polyimide membranes with through holds using ZnO nanowire arrays synthesized via a hydrothermal method as the mold. The nanoporous polyimide membrane was obtained by etching the ZnO with a NaOH solution after the polyimide was fully cured. Kim et al. (Kim, 2009, Materials Letters, 63, 933) fabricated a porous polyimide membrane using a Si nanowire array as a master mold. In their processes, liquid polyimide was cured on a Si nanowire array synthesized by the chemical vapor deposition (CVD) method, followed by etching the Si nanowire array using xenon difluoride (XeF₂). However, this method renders the mold non-reusable, resulting in significant cost increase.

In this study, a new method to prepare thick PDMS templates with aligned holes was developed. A Si master mold with pillars that were hundreds of micrometers long was prepared, from which PDMS templates with a thickness of 200 to 300 μm were fabricated. The PDMS template was then used for electrodeposition of Cu MWs. These new processes can be potentially extended to prepare other 1D metal and alloys structures with customized geometry, length, diameter, and density, paving the way for new applications of 1D metal structures. In addition, a scratch test was conducted on the Cu MWs array to investigate the bonding strength of the Cu MWs array to the Cu substrate.

Currently, the most widely used and commercially available templates for the electrodeposition of one-dimensional (1D) metal structures are anodic aluminum oxide (AAO) and polycarbonate track etched (PCTE) templates. Due to technical difficulties in the fabrication process of these templates, the thickness is limited to a few tens of microns (<60 μm). However, some applications, such as advanced seal applications, require microstructures that are longer, up to hundreds of microns. In this study, polydimethylsiloxane (PDMS) templates with a thickness of 200˜300 μm were prepared and used for the electrodeposition of Cu microwires (MWs) for the first time. The technical processes demonstrated here can be extended to prepare other 1D metal structures with customized geometry, length, diameter, and density, paving the way for new applications of 1D metal structures. Additionally, a scratch test was conducted on the synthesized Cu MWs array to examine the bonding strength of the Cu MWs array to the Cu substrate. The results showed that the Cu MWs array has a very strong bonding strength to its underlying Cu substrate, such that no delamination of Cu MWs occurred under a normal load of 3 N during scratch testing.

The present invention describes a method to fabricate polymer based template for the synthesis of small scale microstructures. The polymer templates are fabricated from Si master templates via a series of processing steps. The polymer templates with carefully controlled geometry can then be used to synthesize microstructures of various metals and alloys. This process can produce microstructures up to hundreds of micrometers, which have not been reported previously, including dimensional structures with aspect ratios around 1:15.

The current invention can create microstructures with a length on the order of several hundred micrometers and uses a Si master template that can be repeatedly used, which can significantly reduce processing costs. Membranes for various chemical engineering applications as well as thermal and electrical interfacial materials are also provided.

This invention describes a method to fabricate polymer templates that can be subsequently used to synthesize one-dimensional metal or alloy structures (e.g., nanowires and micro arrays). The templates can be made from various polymeric materials while the nano- and micro-structures can be synthesized from various metals and alloys. The following example illustrates this process that involves preparation of polydimethylsiloxane (PDMS) templates and synthesis of copper (Cu) microwires using such templates.

One dimensional Cu microwires array was grown on copper substrates using a customized PDMS template in three steps, including 1) preparation of Si micropillar master, 2) preparation of PDMS template with through holes and 3) electrodeposition of Cu microwires array using PDMS template.

The present invention has potential uses in membranes for various chemical engineering applications and in thermal and electrical interfacial materials.

The experimental methods used herein will now be described.

### Preparation of Si Micropillar Masters

The preparation of the Si micropillar master involved the following substeps: (1) Deposition of a 2 μm thick SiO₂ layer on a 4″ Si wafer using plasma-enhanced chemical vapor deposition (PECVD, Oxford Plasmalab 100, Oxfordshire, UK). (2) Spin coating of a layer of SPR220-7 photoresist (Shipley, USA) on the SiO₂-deposited wafer. (3) Exposure of the wafer with a photomask using a SUSS MicroTec MA6 Mask Aligner (SUSS MicroTec AG, Garching, Germany). (4) Removal of the exposed photoresist using MF-26A developer (Rohm and Haas Electronic Materials LLC, Philadelphia, PA, USA). (5) Etching of the SiO₂ layer using reactive ion etching (RIE) (Plasmalab 80 Plus, Oxford Instruments, Oxfordshire, UK). (6) Fabrication of the Si micropillar master mold using deep reactive ion etching (DRIE) (STS Pegasus, SPTS Technologies, Newport, UK) until the height of the pillars reached 200 to 300 μm.

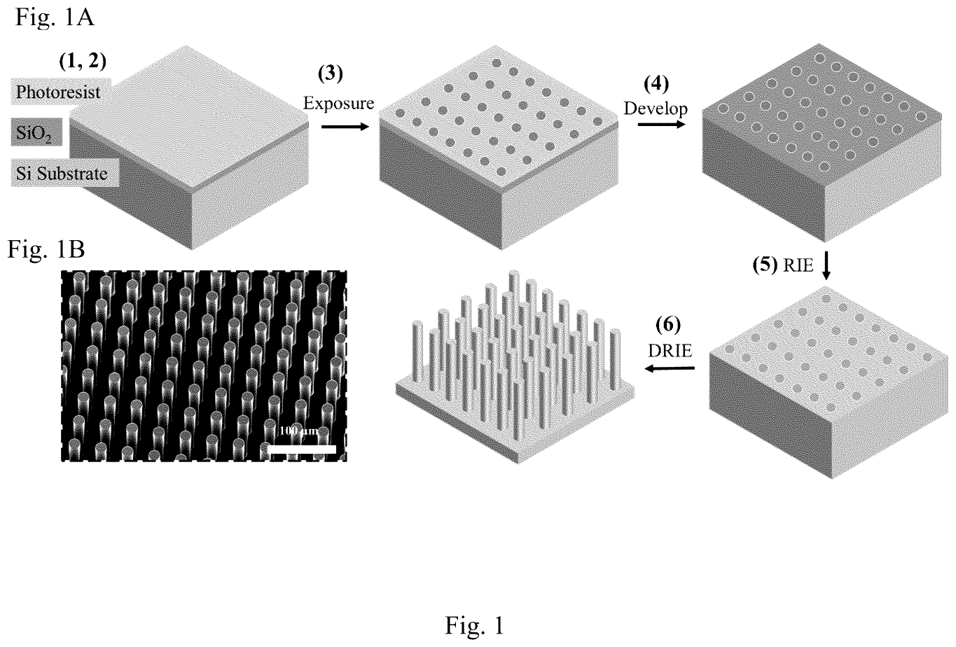

Alternatively, the process of preparation of the Si (Si) micropillar master includes the following steps shown in FIG. 1A: (1) a 2 μm thick SiO₂ layer was deposited on a 4 inch Si wafer by plasma enhanced chemical vapor deposition (PECVD) using a Oxford PlasmaLab 100 system; (2) a layer of SPR220-7 photoresist was spin coated on the SiO₂ deposited wafer; (3) the wafer was then exposed with a photomask using SUSS MicroTec MA6 Gen3 Mask Aligner; (4) the exposed photoresist was removed using MF-26A developer; (5) SiO₂ layer was etched using reactive ion etching (Oxford 80 Plus RIE); (6) the Si micropillar master was fabricated using deep reactive ion etching (SPTS Si DRIE) until the height of pillars was about 250 μm. An example of fabricated Si micropillar master is shown in FIG. 1B.

Preparation of PDMS Templates with Through Holes

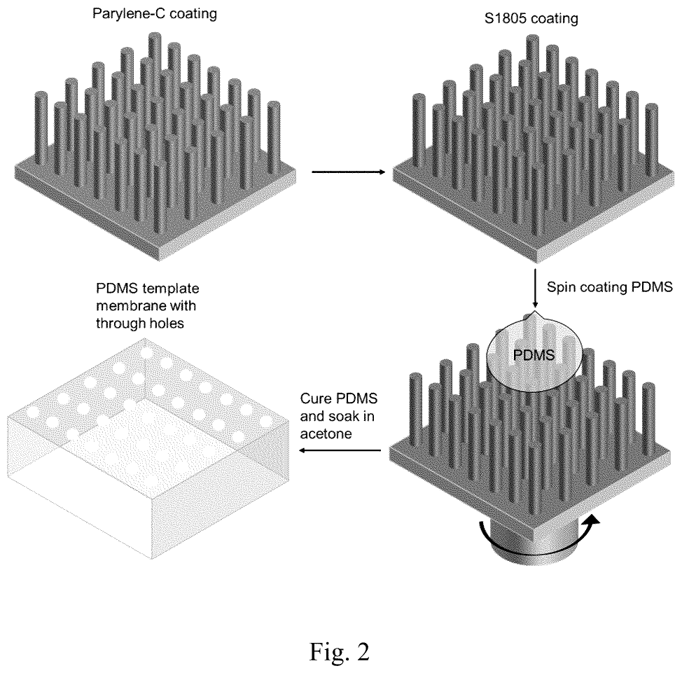

The preparation of the PDMS template with through holes involved the following substeps, as shown in FIG. 2: (1) Conformal coating of an intermediate layer of Parylene-C (amount of Parylene-C dimer: 3 g) on the Si micropillar master using SCS Parylene coater (PDS 2010, Specialty Coating Systems, Indianapolis, IN, USA). (2) Spray coating of a sacrificial layer of Shipley S1805 photoresist on the master using SUSS MicroTec AS8 AltaSpray (SUSS MicroTec, Garching, Germany). (3) Spin coating of Polydimethylsiloxane (PDMS, Sylgard 184 silicone elastomer kit, Dow Corning, Midland, MI, USA) (base elastomer to curing agent mass ratio=10:1) onto the sample at a spin speed of 3500 rpm. (4) Curing of the PDMS under ambient conditions for 48 hours. (5) Scoring of the edge of the wafer with a tweezer and release of the PDMS membrane by soaking the sample in acetone. (6) After the sacrificial layer was fully dissolved, the floating PDMS membrane with through holes was obtained. The obtained PDMS membrane was further washed with deionized water and dried in the air for the next step.

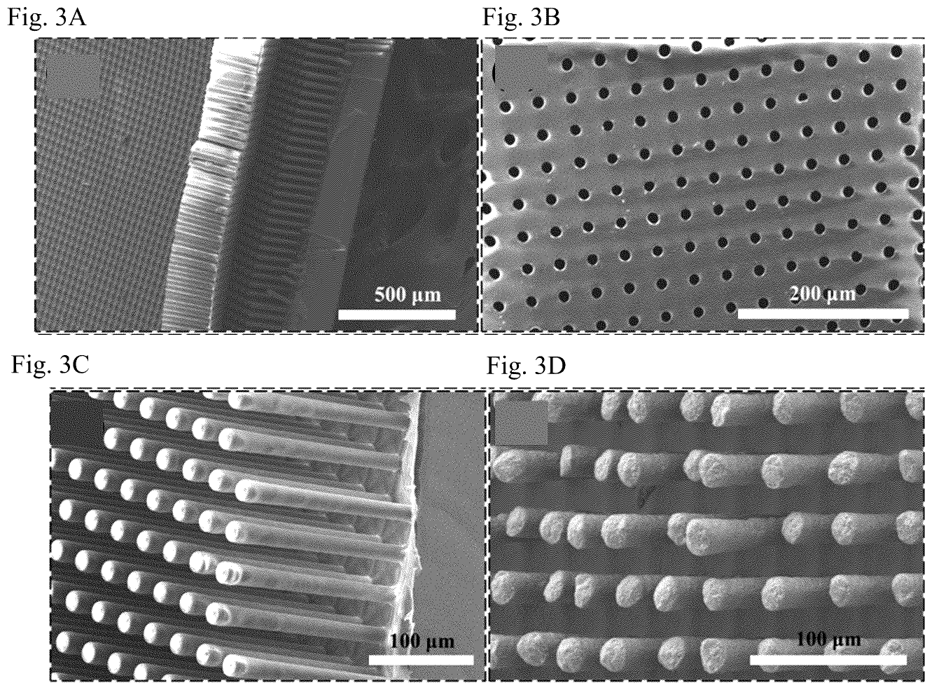

Alternatively, the process of preparation of the polydimethylsiloxane (PDMS) template with through holes includes the following steps: (1) an intermediate layer of Parylene-C was conformally coated on the Si micropillar master using a SCS Parylene coater; (2) a sacrificial layer of Shipley S1805 photoresist was spray coated on the master using SUSS MicroTec AS8 AltaSpray; (3) PDMS (mass ratio of base elastomer to curing agent=10:1) was spin coated onto the sample at the spin speed of 3500 rpm; (4) the PDMS was cured under ambient conditions for 48 hours; (5) the edge of the wafer was scored with tweezers and the PDMS membrane was released by soaking the sample in acetone; (6) after the sacrificial layer was fully dissolved, the floating PDMS membrane was removed from the acetone, as shown in FIG. 3A and FIG. 3B. The Si micropillar master was not damaged after PDMS template was released, shown in FIG. 3C, showing great robustness.

### Electrodeposition of Cu MWs Using PDMS Template

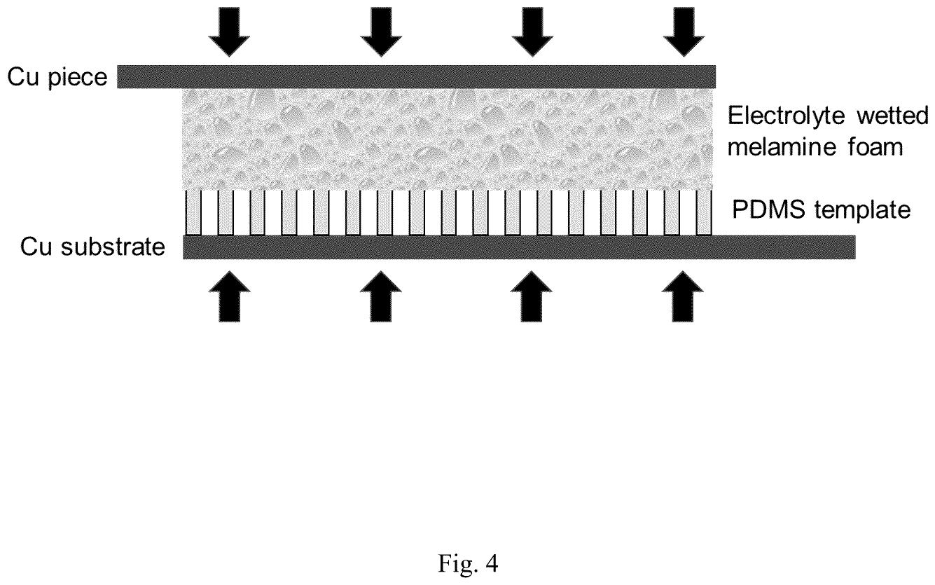

Since PDMS is highly hydrophobic, the free-standing PDMS template membrane was first treated with oxygen plasma for 10 minutes to make the surface hydrophilic using a plasma cleaner (PDC-32G, Harrick Plasma Inc., Ithaca, NY, USA). The plasma treated PDMS template was then attached to a Cu substrate (FIG. 4). A piece of melamine foam wetted with an electrolyte solution (0.6 M CuSO₄ as Cu precursor+1 M H₂SO₄ to increase the conductivity) was placed on top of the PDMS template. The wetted melamine provided enough Cu precursor for Cu MWs growth and ensured the presence of a conductive channel between the electrodes. A Cu piece was aligned on top of the melamine foam and used as a counter electrode. The Cu substrate with the attached PDMS membrane served as the working electrode. Uniform pressure was applied to secure the entire structure. A constant voltage of −0.4 V was applied between the working and counter electrodes using an electrochemical workstation (Versastat 3, Ametek, Berwyn, PA, USA) at room temperature. After approximately 2 hours of growth, the Cu substrate with Cu MWs was removed from the fixture, rinsed with deionized water and ethanol, and dried in air. Finally, the PDMS template was detached, and the Cu MW array was obtained. The detached PDMS template can be reused if handled gently without damage.

Alternatively, the free standing PDMS membrane was first oxygen plasma treated for 10 minutes using a Harrick Plasma cleaner PDC-32G (3 inch diameter×6.5 inch length Pyrex chamber) (Harrick Plasma Inc., Ithaca, NY, USA) to make the surface hydrophilic. A rectangular container with a square opening on the bottom was machined as a three-electrode electrochemical cell. A piece of PDMS template was attached on a copper substrate, which was then used to seal the opening of the container where PDMS served as a gasket. The PDMS membrane faces upwards, allowing it to be exposed to the electrolyte during electrodeposition. Two paper clips were used to clamp the sample with the container and secure the PDMS membrane to the copper substrate. The electrolyte solution consists of 0.6 M CuSO₄ (as copper precursor) and 1 M H₂SO₄ (to increase the conductivity). The copper substrate with PDMS membrane attached was the working electrode. Another oxygen free copper sheet was used as the counter electrode. Potentiostatic electrodeposition was performed with a constant voltage of −0.4 V versus Ag/AgCl reference electrode at room temperature. After 60 minutes of growth, the copper substrate with Cu microwires was removed from the fixture, rinsed with deionized water, and ethanol, and dried in air. Finally, the PDMS template was removed and Cu microwires array was obtained as shown in FIG. 3D.

### Investigation of Bonding Strength Between Cu MWs and Cu Substrate by Scratch Test

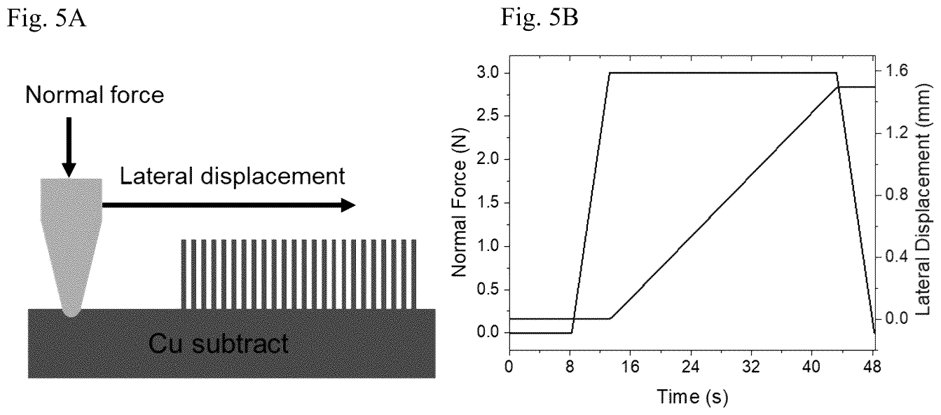

Scratch tests were conducted on the Cu MWs array using a Hysitron Triboindenter (TI-900, Hysitron Inc, Minneapolis, MN, USA). A conical indenter with a radius of 100 μm was used for the tests. During the constant load scratch test, the indenter traveled horizontally from the exposed bare substrate to the Cu MWs region under a constant normal load (FIG. 5A) (Lahiri et al., 2011, ACS Nano, 5, 780; Das et al., 2013, Carbon, 59, 121). The constand load scratch tests were performed under a series of increased normal loads up to 3 N (corresponding pressure: 169.28 MPa) and a scratch length of 1.5 mm from the bare substrate to the Cu MWs array regions. An example load function is shown in FIG. 5B, where the normal load is 3 N. The scratch segment started at 13 s and stopped at 43 s, followed by unloading at the time of 43 s.

The results and discussion of the above experiments will now be discussed.

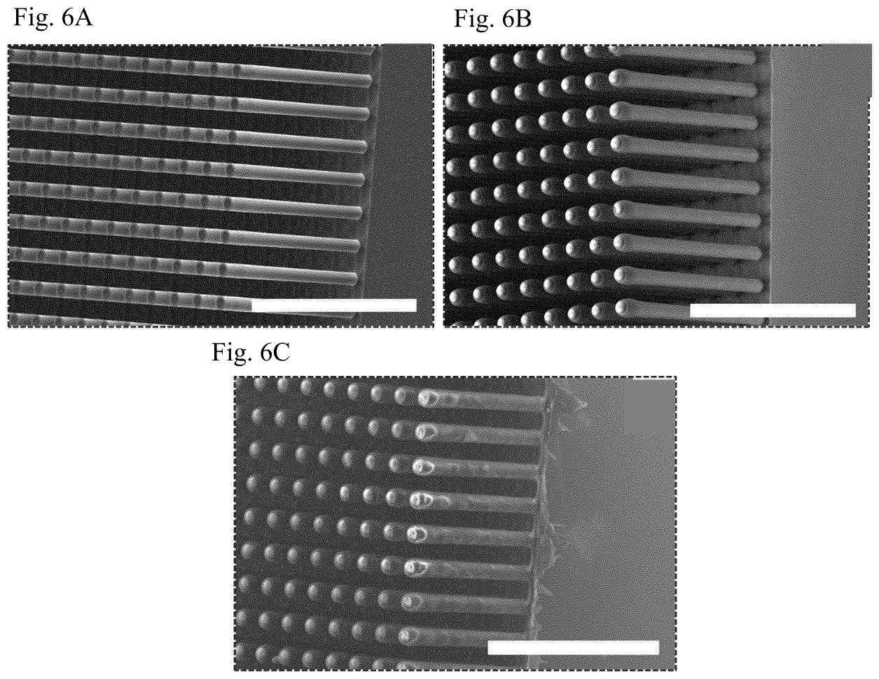

The SEM images show the titled view of a bare Si micropillars array master, Parylene-C coated Si micropillars array master, and S1805 coated Si micropillars array master in FIG. 6A through FIG. 6C, respectively. It can be observed that the Si micropillars are uniformly distributed and stand on the Si substrate in FIG. 6A. The length and diameter of the Si pillars are approximately 300 μm and 17 μm, respectively. It was observed that the obtained Si pillars have a smaller diameter than the designed diameter of 20 μm, which may be attributed to the previous exposure step. The length of the pillars is dependent on the duration of the DRIE process. After Parylene-C coating, the top ends of the Si pillars became round, and the diameter of the Si pillars increased to around 19 μm (FIG. 6B). The diameter of the Si pillars was further increased to around 20 μm, and the surface of the Si pillars became rougher after S1805 coating in FIG. 6C.

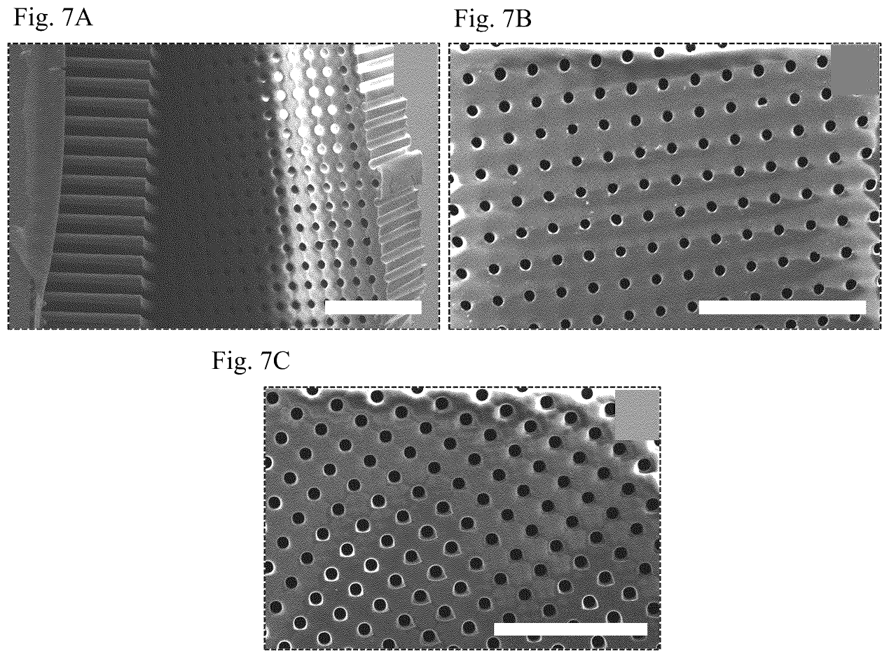

FIG. 7A depicts a piece of PDMS about to be released from the Si pillar master, with clear through holes visible on the cross-sectional edge of PDMS. Some Parylene-C debris is also observed on the bottom ends of the Si pillars. The top and bottom surfaces of the PDMS template membrane are shown in FIG. 7B and FIG. 7C, respectively. The diameters of the holes on the top side and bottom side are slightly different (with an approximate difference of 1.5 μm), indicating the tapered feature of the holes in the PDMS template. This taper feature is a result of the tapered Si pillars from DRIE process, which facilitates the release of PDMS from the Si pillar array during the PDMS fabrication step. Furthermore, the taper feature of the holes in the PDMS template can also aid in detaching it from the grown Cu MWs array if the PDMS template is placed with the large diameter side onto the growing Cu substrate during the growth process.

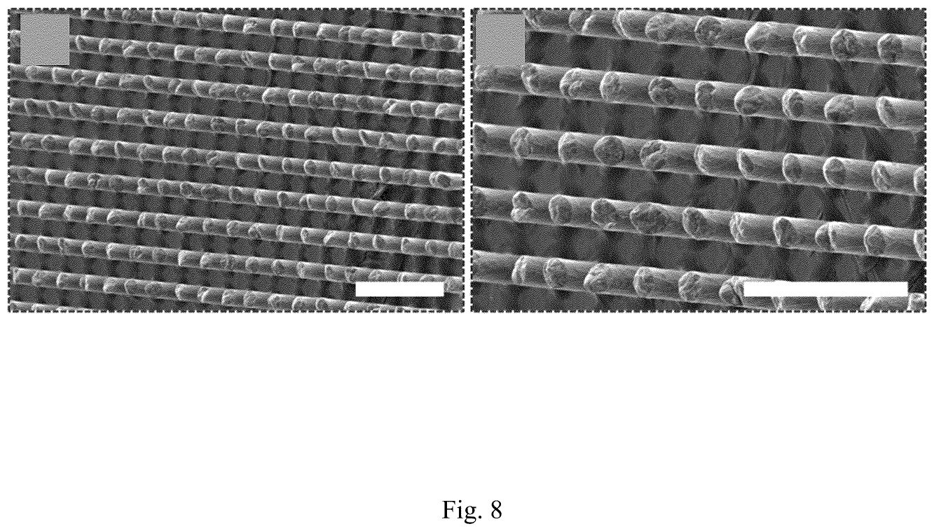

The SEM images in FIG. 8 display the synthesized Cu MWs array. The Cu MWs, with a diameter of 20 μm, spacing of 20 μm, and length of 265±14 μm, are well aligned and uniformly distributed on the Cu substrate. The geometry, including shape, diameter, and spacing, is replicated from the holes in the PDMS template. The length of the Cu MWs is dependent on the growth time. Due to the nonuniformity of the deposition process, the lengths of the Cu MWs showed variation and the surface of the top ends of Cu MWs is not smooth. In some cases, the Cu MWs exhibited porosity and were not perfectly solid. This could be improved by decreasing the electrolyte concentration and the voltage during growth, as well as enhancing the flowability of the electrolyte solution, such as adding vibration to the growth setup.

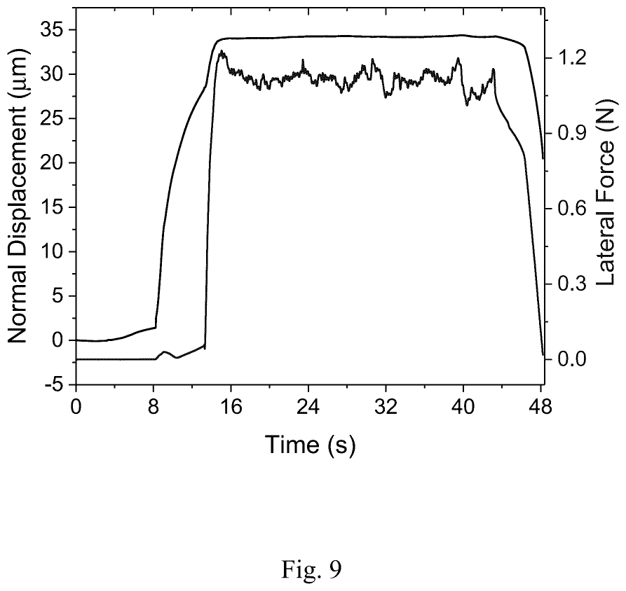

The practical applications of 1D structures require strong bonding between them and their substrates to prevent unexpected structural damage during usage and ensure the long-term reliability and stability of devices. Therefore, there is great interest in quantitatively evaluating the bonding strength of the structures to their underlying substrates. Previous research indicates that the constant load scratch technique can be utilized to evaluate the bonding strength of nanostructed coatings to their substrates, such as carbon nanotubes (CNTs) (Lahiri et al., 2011, ACS Nano, 5, 780) and graphene (Das et al., 2013, Carbon, 59, 121). Here, a constant scratch test was also conducted on the Cu MW array to investigate the bonding strength between Cu MWs and the Cu substrate. The typical lateral force and normal displacement vs. time curves obtained from the scratch test are depicted in FIG. 9. It can be observed that the normal displacement stabilizes at around 34 μm. Small undulations in the lateral force curve were also observed, which may be related to the spacing between Cu MWs in the array.

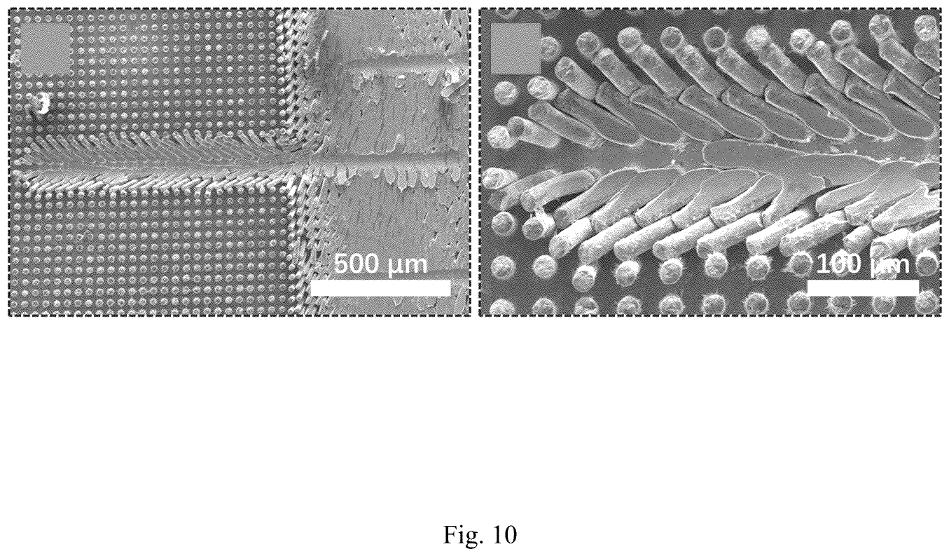

The SEM image in FIG. 10 shows the scratch scar after the scratch test. No delamination of Cu MWs from the substrate was observed, even under a normal load of 3 N. This indicates a very strong bonding between the Cu MWs array and the Cu substrate, which is extremely beneficial for practical application. The same scratch test was conducted on Cu NWs with a diameter of 0.4 μm and a length up to 22 μm. It was found that the Cu NWs array delaminated under a normal load of 104 mN. The adhesion energy per Cu NW (0.4 μm diameter) is 363.25 pJ. The contact area of single Cu MW (20 μm diameter) is 2500 times that of Cu NW. So, the adhesion energy per Cu MW is estimated to be 908125 pJ. It was believed that the diameter of 1D structures greatly affects their bonding to the substrate. A larger diameter provides a larger contact area between the structure and substrate. Consequently, the bonding strength of Cu MWs was dramatically enhanced. The adhesion energy per Cu NW (0.4 μm diameter) is 363.25 pJ, as reported in previous work. The contact area between a single Cu MW and the substrate is 2500 times that of a single Cu NW with a diameter of 0.4 μm. Therefore, the estimated adhesion energy per Cu MW is 908125 pJ.

In summary, a Cu MW array with a strong bond to the growth substrate was electrodeposited using fabricated PDMS templates from a Si master mold. By designing the photomask with different parameters and adjusting the etching conditions in DRIE, various PDMS template membranes with holes of different geometry, diameter, length, and spacing can be fabricated. This enables the preparation of various 1D Cu structures. The demonstrated processes can also be extended to other metal or metal compound structures, opening up new possibilities for applications of metal or metal compound structures, such as microelectromechanical systems (MEMS), microscale electrodes, microscale sensing.

Further, a novel process was developed to fabricate thick PDMS template membrane with 1D aligned through holes using a Si micropillar master mold. The diameter of the Si pillars is smaller than the designed diameter of 20 μm, and the length of the pillars depends on the duration of the DRIE process. It was observed that the holes in the obtained PDMS template exhibited a tapered feature due to the tapered Si pillars resulting from the DRIE process. The PDMS template was utilized to grow Cu MW arrays via electrodeposition. The geometry, diameter, and spacing of the electrodeposited Cu MWs, are replicated from the holes in the PDMS template. A constant load scratch test was conducted on Cu MWs to evaluate the mechanical integrity. The results demonstrated that no delamination occurred, even under a pressure of 169.28 MPa, indicating a very strong bonding between the Cu MWs and the Cu substrate. This substantial bonding strength will greatly facilitate the practical applications of Cu MWs. This new process can be expanded to prepare other 1D structures with customized geometry, length diameter and density, thereby enabling new applications of 1D metal or alloy structures, such as, microelectromechanical systems (MEMS), microscale electrodes, microscale sensing.

### Laser Fabricated Templates

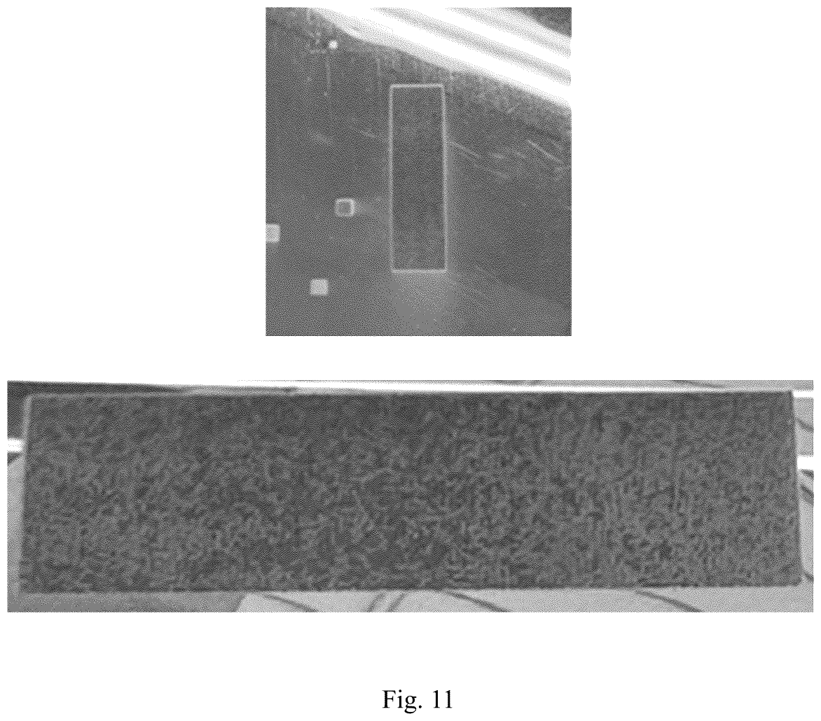

The present invention further provides a method of generating patterned holes on polymer films, which can be used as the template to guide the growth of arrays of micro metal/allow wires. This new process starts with obtaining thin films of polymer films, such as PDMS, which can be purchased from commercial sources or synthesized. The thickness of the films is selected to match the length of the micro-wires to be synthesized. The next step is to use a design software (commercial or generic) to generate a pattern of holes that will be created on the film. In one example, arrays of circular holes with diameters of ˜30 micrometers were designed, with a spacing of ˜30 micrometers. To create such patterns, one can use a high-energy laser to drill holes in the polymer films. The present example uses an IPG Photonics IX-255 Excimer Laser with a wavelength of 193 nm and a power of 25 J/cm². FIG. 11 shows the low-mag and high-mag images of PDMS films with hold patterns created using this method. Once these films are created, they are cleaned with DI water and dried. They can then be used to growth metal microwires using the previously described electrochemical method.

This new approach using laser micro-machining offers fast design and manufacturing turn-around time compared to previously described lithography method. It is more cost effective for small-scale manufacturing. On the other hand, the lithography based template fabrication approach offers better accuracy and the unit cost can be lower for large amount of order.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of fabricating a template for the synthesis of at least one microstructure having a controlled geometry, wherein the method comprises the steps of:
providing a Si substrate;
depositing a layer of an oxide onto at least a portion of the surface of the Si substrate to provide a wafer;
etching the wafer to provide a master mold comprising at least one pillar;
coating the at least one pillar and at least a portion of the surface of the master mold with a polymeric material to generate the template; and
releasing the template from the master mold;
wherein the height of the at least one pillar is 100 μm to 1000 μm.

2. The method of claim 1, wherein the oxide is silicon oxide.

3. The method of claim 1, wherein the step of etching the wafer is performed using reactive-ion etching.

4. The method of claim 1, wherein the polymeric material is an elastomer.

5. The method of claim 1, wherein the polymeric material comprises polydimethylsiloxane.

6. The method of claim 1, wherein the step of coating the at least one pillar and at least a portion of the surface of the master mold with a polymeric material comprises spin coating of the polymeric material onto the master mold.

7. A template synthesized using the method of claim 1.

8. A method of fabricating a template for the synthesis of at least one microwire having a controlled geometry, comprising the steps of:
providing a polymeric material; and
drilling a plurality of holes into the polymeric material;
wherein the plurality of holes have an average width between 5 μm and 50 μm and an average spacing between 5 μm and 50 μm.

9. The method of claim 8, wherein the polymeric material is an elastomer.

10. The method of claim 8, wherein the step of drilling is performed using a laser.

11. The method of claim 8, wherein the plurality of holes are cylindrical.

12. A template synthesized using the method of claim 8.

13. A method of making a microstructure comprising the steps of:
providing a template comprising a plurality of pores having an average depth of 100 μm to 1000 μm;
attaching the template to a substrate;
exposing the template to a solution comprising a metal precursor; and
reducing the metal precursor, thereby growing the microstructure on the template.

14. The method of claim 13, wherein the template is flexible.

15. The method of claim 13, wherein the plurality of pores is cylindrical.

16. The method of claim 13, wherein the solution comprising a metal precursor comprises the metal precursor in a concentration of 0.01 M to 5.0 M.

17. The method of claim 13, wherein the metal precursor comprises copper.

18. The method of claim 13, wherein the step of reducing the metal precursor is performed by supplying the solution with a constant voltage having a magnitude of 0.1 V to 1.0 V.

19. The method of claim 13, wherein the microstructure is selected from the group consisting of a wire, a microwire, a nanowire, and a filament.

20. A microwire synthesized using the method of claim 13.
